(19) United States
(12) Patent Application Publication
(10) Pub. No.: US 2024/0314753 A1
(43) Pub. Date: Sep. 19, 2024

(54) DISTRIBUTED TONE TRANSMISSION IN A MULTIPLE BASIC SERVICE SET NETWORK TOPOLOGY

(71) Applicant: QUALCOMM Incorporated, San Diego, CA (US)

(72) Inventors: Lin Yang, San Diego, CA (US); Bin Tian, San Diego, CA (US); Youhan Kim, Saratoga, CA (US)

(21) Appl. No.: 18/185,251

(22) Filed: Mar. 16, 2023

(51) Int. Cl. H04W 72/0453; H04W 56/00

(52) U.S. Cl. CPC H04W 72/0453; H04W 56/001; H04L 5/0007

(57) ABSTRACT

Methods, systems, and devices for wireless communications are described. A wireless station (STA) (for example, an access point (AP) or a non-AP STA) may transmit a message to one or more STAs in a multiple basic service set (BSS) system that indicates one or more distributed resource units (RUs) for the STAs to use for communications, in which each distributed RU includes a respective set of tones interspersed within a channel bandwidth such that tones of different BSSs are interleaved. For example, a coordinating STA may indicate respective distributed RUs assigned to each BSS, and may communicate with the STAs using tones of the distributed RUs for the BSS supported by the coordinating STA. In some other examples, a STA may indicate occupied distributed RUs and a permission condition to another STA, such that the other STA may use unoccupied distributed RUs for communications in accordance with the permission condition.

### TECHNICAL FIELD

This disclosure relates generally to wireless communication, and more specifically, to distributed tone transmission in a multiple basic service set (BSS) network topology.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some examples, a wireless communication system may implement a multiple BSS (multi-BSS) network topology that includes multiple APs each associated with a respective BSS. In such a multi-BSS network, an AP in a first BSS may control, or otherwise communicate with, multiple STAs in multiple respective BSSs including those managed by other APs of the multi-BSS network. The APs of the BSSs in the multi-BSS network are connected with one another via wired or wireless links in a distributed system fashion. In some cases, an AP may transmit or receive information about STAs in other BSSs. Such an AP may be regarded or referred to as a “master” AP or a “controller” AP. The controller AP or master AP may coordinate a tone-interleaved transmission according to a distributed tone plan. For a distributed tone plan, multiple STAs from the multiple BSS network topology may collectively transmit a multiplexed transmission by transmitted their respective data on respective tones that are distributed and interleaved across the channel bandwidth, referred to as a “spreading” bandwidth, such that tones associated with a given STA are separated by tones associated with other STAs. The multi-BSS network topology may be useful for, among other operations, more intelligent decision making between STAs and APs in different BSSs due to an AP receiving information about STAs in different BSSs, more coordinated communication by having an AP control (for example, manage) operation of STAs in different BSSs, and/or more efficient communication (for example, due to the tone-interleaved transmission).

For some WLANs, a regulatory body may impose a power spectral density (PSD) limit for one or more communication channels or for an entire band (for example, a 6 GHz band). The PSD is a measure of transmit power as a function of a unit bandwidth (such as per 1 MHz) and the total transmit power of a transmission is the product of the PSD and the total bandwidth by which the transmission is sent. In some examples in which transmissions are subject to a PSD limit, one or more wireless communication devices may implement a greater transmission bandwidth to allow for an increase in the total transmit power, which may extend coverage of the wireless communication devices. In some specific examples of WLANs, to overcome or extend the PSD limit, a wireless communication device may implement an Extremely High Throughput (EHT) duplicate (DUP) mode for a transmission, by which data in a payload portion of a physical layer protocol data unit (PPDU) is modulated for transmission over a “base” frequency subband, such as a first resource unit (RU) of an orthogonal frequency division multiple access (OFDMA) transmission, and copied over (for example, duplicated) to another frequency subband, such as a second RU of the OFDMA transmission. In some such examples, the data mapped to the first RU may be mapped in accordance with a dual carrier modulation (DCM) scheme, such that the first RU carries two copies of the data. Similarly, the data mapped to the second RU may be mapped in accordance with the DCM scheme, such that the second RU also carries two copies of the data. As a result, four copies of the data are spread across the first and second RUs. As such, while the data rate for transmission of each copy of the user data using the DUP mode may be the same as a data rate for a transmission using a “normal” mode, the transmit power for the transmission using the EHT DUP mode may be essentially multiplied by the number of copies of the data being transmitted, at the expense of requiring an increased bandwidth. As such, using the EHT DUP mode may reduce spectrum efficiency when compared with the distributed tone transmission.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a wireless access point (AP). The method includes transmitting, to a set of multiple wireless stations (STAs) associated with a set of multiple basic service sets (BSSs), a first message including, for each BSS of the set of multiple BSSs, an indication of one or more respective distributed resource units (RUs) assigned to the BSS, each distributed RU including a respective set of tones interspersed within a channel bandwidth such that tones of the respective set of tones are interleaved with tones of at least one distributed RU assigned to at least one other BSS of the set of multiple BSSs and communicating with one or more wireless STAs, of the set of multiple wireless STAs, associated with one or more BSSs, of the set of multiple BSSs, associated with the wireless AP using the respective set of tones of each of the one or more respective distributed RUs assigned to the one or more BSSs.

Another innovative aspect of the subject matter described in this disclosure can be implemented by an apparatus for wireless communication at an AP. The apparatus may include a processor, memory coupled with the processor, and instructions stored in the memory. The instructions may be executable by the processor to cause the apparatus to transmit, to a set of multiple wireless STAs associated with a set of multiple BSSs, a first message including, for each BSS of the set of multiple BSSs, an indication of one or more respective distributed RUs assigned to the BSS, each distributed RU including a respective set of tones interspersed within a channel bandwidth such that tones of the respective set of tones are interleaved with tones of at least one distributed RU assigned to at least one other BSS of the set of multiple BSSs and communicate with one or more wireless STAs, of the set of multiple wireless STAs, associated with a first BSS, of the set of multiple BSSs, associated with the wireless STA using the respective set of tones of the one or more respective distributed RUs assigned to the first BSS.

Another innovative aspect of the subject matter described in this disclosure can be implemented by an apparatus for wireless communication at an AP. The apparatus may include means for transmitting, to a set of multiple wireless STAs associated with a set of multiple BSSs, a first message including, for each BSS of the set of multiple BSSs, an indication of one or more respective distributed RUs assigned to the BSS, each distributed RU including a respective set of tones interspersed within a channel bandwidth such that tones of the respective set of tones are interleaved with tones of at least one distributed RU assigned to at least one other BSS of the set of multiple BSSs and means for communicating with one or more wireless STAs, of the set of multiple wireless STAs, associated with a first BSS, of the set of multiple BSSs, associated with the wireless STA using the respective set of tones of the one or more respective distributed RUs assigned to the first BSS.

Another innovative aspect of the subject matter described in this disclosure can be implemented by a non-transitory computer-readable medium storing code for wireless communication at an AP. The code may include instructions executable by a processor to transmit, to a set of multiple wireless STAs associated with a set of multiple BSSs, a first message including, for each BSS of the set of multiple BSSs, an indication of one or more respective distributed RUs assigned to the BSS, each distributed RU including a respective set of tones interspersed within a channel bandwidth such that tones of the respective set of tones are interleaved with tones of at least one distributed RU assigned to at least one other BSS of the set of multiple BSSs and communicate with one or more wireless STAs, of the set of multiple wireless STAs, associated with a first BSS, of the set of multiple BSSs, associated with the wireless STA using the respective set of tones of the one or more respective distributed RUs assigned to the first BSS.

One innovative aspect of the subject matter described in this disclosure can be implemented in a method for wireless communication at a wireless STA associated with a first BSS. The method includes transmitting, in a preamble of a transmission associated with one or more occupied distributed RUs, an indication of the one or more occupied distributed RUs and an indication of a resource condition corresponding to a second wireless STA using one or more unoccupied distributed RUs, each distributed RU including a respective set of tones interspersed within a channel bandwidth such that tones of the respective set of tones are interleaved with tones of at least one distributed RU assigned to at least one other BSS of a set of multiple BSSs that includes the first BSS and communicating, for a duration of the transmission, with one or more wireless STAs using the respective set or sets of tones of the one or more occupied distributed resource units.

Another innovative aspect of the subject matter described in this disclosure can be implemented by an apparatus for wireless communication at a wireless STA associated with a first BSS. The apparatus may include a processor, memory coupled with the processor, and instructions stored in the memory. The instructions may be executable by the processor to cause the apparatus to transmit, in a preamble of a transmission associated with one or more occupied distributed RUs, an indication of the one or more occupied distributed RUs and an indication of a resource condition corresponding to a second wireless STA using one or more unoccupied distributed RUS, each distributed RU including a respective set of tones interspersed within a channel bandwidth such that tones of the respective set of tones are interleaved with tones of at least one distributed RU assigned to at least one other BSS of a set of multiple BSSs that includes the first BSS and communicating, for a duration of the transmission, with one or more wireless STAs used the respective set or sets of tones of the one or more occupied distributed resource units.

Another innovative aspect of the subject matter described in this disclosure can be implemented by an apparatus for wireless communication at a wireless STA associated with a first BSS. The apparatus may include means for transmitting, in a preamble of a transmission associated with one or more occupied distributed RUs, an indication of the one or more occupied distributed RUs and an indication of a resource condition corresponding to a second wireless STA using one or more unoccupied distributed RUs, each distributed RU including a respective set of tones interspersed within a channel bandwidth such that tones of the respective set of tones are interleaved with tones of at least one distributed RU assigned to at least one other BSS of a set of multiple BSSs that includes the first BSS and means for communicating, for a duration of the transmission, with one or more wireless STAs using the respective set or sets of tones of the one or more occupied distributed resource units.

Another innovative aspect of the subject matter described in this disclosure can be implemented by a non-transitory computer-readable medium storing code for wireless communication at a wireless STA associated with a first BSS. The code may include instructions executable by a processor to transmit, in a preamble of a transmission associated with one or more occupied distributed RUs, an indication of the one or more occupied distributed RUs and an indication of a resource condition corresponding to a second wireless STA using one or more unoccupied distributed RUs, each distributed RU including a respective set of tones interspersed within a channel bandwidth such that tones of the respective set of tones are interleaved with tones of at least one distributed RU assigned to at least one other BSS of a set of multiple BSSs that includes the first BSS and communicating, for a duration of the transmission, with one or more wireless STAs used the respective set or sets of tones of the one or more occupied distributed resource units.

One innovative aspect of the subject matter described in this disclosure can be implemented in a method for wireless communication at a wireless STA. The method may include receiving a first message including, for each BSS of a set of multiple BSSs associated with a set of multiple wireless STAs including the wireless STA, an indication of one or more respective distributed RUs assigned to the BSS, each distributed RU including a respective set of tones interspersed within a channel bandwidth such that tones of the respective set of tones are interleaved with tones of at least one distributed RU assigned to at least one other BSS of the set of multiple BSSs and communicating with one or more wireless STAs, of the set of multiple wireless STAs, associated with a first BSS, of the set of multiple BSSs, associated with the wireless STA using the respective set of tones of the one or more respective distributed RUs assigned to the first BSS.

Another innovative aspect of the subject matter described in this disclosure can be implemented by an apparatus for wireless communication at a wireless STA. The apparatus may include a processor, memory coupled with the processor, and instructions stored in the memory. The instructions may be executable by the processor to cause the apparatus to receive a first message including, for each BSS of a set of multiple BSSs associated with a set of multiple wireless STAs including the wireless STA, an indication of one or more respective distributed RUs assigned to the BSS, each distributed RU including a respective set of tones interspersed within a channel bandwidth such that tones of the respective set of tones are interleaved with tones of at least one distributed RU assigned to at least one other BSS of the set of multiple BSSs and communicate with one or more wireless STAs, of the set of multiple wireless STAs, associated with a first BSS, of the set of multiple BSSs, associated with the wireless STA using the respective set of tones of the one or more respective distributed RUs assigned to the first BSS.

Another innovative aspect of the subject matter described in this disclosure can be implemented by an apparatus for wireless communication at a wireless STA. The apparatus may include means for receiving a first message including, for each BSS of a set of multiple BSSs associated with a set of multiple wireless STAs including the wireless STA, an indication of one or more respective distributed RUs assigned to the BSS, each distributed RU including a respective set of tones interspersed within a channel bandwidth such that tones of the respective set of tones are interleaved with tones of at least one distributed RU assigned to at least one other BSS of the set of multiple BSSs and means for communicating with one or more wireless STAs, of the set of multiple wireless STAs, associated with one or more BSSs, of the set of multiple BSSs, associated with the wireless STA using the respective set of tones of each of the one or more respective distributed RUs assigned to the one or more BSSs.

Another innovative aspect of the subject matter described in this disclosure can be implemented by a non-transitory computer-readable medium storing code for wireless communication at a wireless STA. The code may include instructions executable by a processor to receive a first message including, for each BSS of a set of multiple BSSs associated with a set of multiple wireless STAs including the wireless STA, an indication of one or more respective distributed RUs assigned to the BSS, each distributed RU including a respective set of tones interspersed within a channel bandwidth such that tones of the respective set of tones are interleaved with tones of at least one distributed RU assigned to at least one other BSS of the set of multiple BSSs and communicate with one or more wireless STAs, of the set of multiple wireless STAs, associated with a first BSS, of the set of multiple BSSs, associated with the wireless STA using the respective set of tones of the one or more respective distributed RUs assigned to the first BSS.

One innovative aspect of the subject matter described in this disclosure can be implemented in a method for wireless communication at a wireless STA associated with a first BSS. The method may include receiving, in a preamble of a transmission associated with one or more occupied distributed RUs, an indication of the one or more occupied distributed RUs and an indication of a resource condition corresponding to the wireless STA using one or more unoccupied distributed RUs, each distributed RU including a respective set of tones interspersed within a channel bandwidth such that tones of the respective set of tones are interleaved with tones of at least one distributed RU assigned to at least one other BSS of a set of multiple BSSs that includes the first BSS and communicating, for a duration of the transmission, with one or more wireless STAs using the respective set of tones of the one or more unoccupied distributed resource units in accordance with the resource condition.

Another innovative aspect of the subject matter described in this disclosure can be implemented by an apparatus for wireless communication at a wireless STA associated with a first BSS. The apparatus may include a processor, memory coupled with the processor, and instructions stored in the memory. The instructions may be executable by the processor to cause the apparatus to receive, in a preamble of a transmission associated with one or more occupied distributed RUs, an indication of the one or more occupied distributed RUs and an indication of a resource condition corresponding to the wireless STA using one or more unoccupied distributed RUs, each distributed RU including a respective set of tones interspersed within a channel bandwidth such that tones of the respective set of tones are interleaved with tones of at least one distributed RU assigned to at least one other BSS of a set of multiple BSSs that includes the first BSS and communicating, for a duration of the transmission, with one or more wireless STAs used the respective set of tones of the one or more unoccupied distributed resource units in accordance with the resource condition.

Another innovative aspect of the subject matter described in this disclosure can be implemented by an apparatus for wireless communication at a wireless STA associated with a first BSS. The apparatus may include means for receiving, in a preamble of a transmission associated with one or more occupied distributed RUs, an indication of the one or more occupied distributed RUs and an indication of a resource condition corresponding to the wireless STA using one or more unoccupied distributed RUs, each distributed RU including a respective set of tones interspersed within a channel bandwidth such that tones of the respective set of tones are interleaved with tones of at least one distributed RU assigned to at least one other BSS of a set of multiple BSSs that includes the first BSS and means for communicating, for a duration of the transmission, with one or more wireless STAs using the respective set of tones of the one or more unoccupied distributed resource units in accordance with the resource condition.

Another innovative aspect of the subject matter described in this disclosure can be implemented by a non-transitory computer-readable medium storing code for wireless communication at a wireless STA associated with a first BSS. The code may include instructions executable by a processor to receive, in a preamble of a transmission associated with one or more occupied distributed RUs, an indication of the one or more occupied distributed RUs and an indication of a resource condition corresponding to the wireless STA using one or more unoccupied distributed RUs, each distributed RU including a respective set of tones interspersed within a channel bandwidth such that tones of the respective set of tones are interleaved with tones of at least one distributed RU assigned to at least one other BSS of a set of multiple BSSs that includes the first BSS and communicating, for a duration of the transmission, with one or more wireless STAs used the respective set of tones of the one or more unoccupied distributed resource units in accordance with the resource condition.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless access point (AP) and one or more wireless stations (STAs).

FIGS. 3 and 4 show pictorial diagrams of example wireless communication networks.

FIGS. 5A and 5B show examples of resource diagrams that illustrate distributed tone transmission in a multiple basic service set (BSS) network topology.

FIGS. 6 and 7 show process flows illustrating example processes that support distributed tone transmission in a multiple BSS network topology.

FIGS. 8 through 13 show flowcharts illustrating example processes by a wireless AP that support distributed tone transmission in a multiple BSS network topology.

FIGS. 14 and 15 show block diagrams of an example wireless communication device that support distributed tone transmission in a multiple BSS network topology.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

In some examples, a wireless communication system may implement a multiple BSS (multi-BSS) network topology that includes multiple APs each associated with a respective BSS. In such a multi-BSS network, an AP in a first BSS may control, or otherwise communicate with, multiple STAs in multiple respective BSSs including those managed by other APs of the multi-BSS network. The APs of the BSSs in the multi-BSS network are connected with one another via wired or wireless links in a distributed system fashion. In some cases, an AP may transmit or receive information about STAs in other BSSs. Such an AP may be regarded or referred to as a master AP or a controller AP. For example, the controller AP or master AP may coordinate a tone-interleaved transmission according to a distributed tone plan. For a distributed tone plan, multiple STAs from the multiple BSS network topology may collectively transmit a multiplexed transmission by transmitting their respective data on respective tones that are distributed (interspersed) across a channel bandwidth, referred to as a “spreading” bandwidth, such that tones associated with a given STA are separated by tones carrying data for other STAs. The multi-BSS network topology may be useful for, among other operations, more intelligent decision making between STAs and APs in different BSSs due to an AP receiving information about STAs in different BSSs, more coordinated communication by having an AP control (for example, manage) operation of STAs in different BSSs, and/or more efficient communication (for example, due to the tone-interleaved transmission).

For some WLANs, a regulatory body may impose a power spectral density (PSD) limit for one or more communication channels or for an entire band (for example, a 6 GHz band). The PSD is a measure of transmit power as a function of a unit bandwidth (such as per 1 MHZ) and the total transmit power of a transmission is the product of the PSD and the total bandwidth by which the transmission is sent. In some examples in which transmissions are subject to a PSD limit, one or more wireless communication devices may implement a greater transmission bandwidth to allow for an increase in the total transmit power, which may extend coverage of the wireless communication devices. In some specific examples of WLANs, to overcome or extend the PSD limit, a wireless communication device may implement an Extremely High Throughput (EHT) duplicate (DUP) mode for a transmission, by which data in a payload portion of a physical layer protocol data unit (PPDU) is modulated for transmission over a “base” frequency subband, such as a first resource unit (RU) of an OFDMA transmission, and copied over (for example, duplicated) to another frequency subband, such as a second RU of the OFDMA transmission. In some such examples, the data mapped to the first RU may be mapped in accordance with a dual carrier modulation (DCM) scheme, such that the first RU carries two copies of the data. Similarly, the data mapped to the second RU may be mapped in accordance with the DCM scheme, such that the second RU also carries two copies of the data. As a result, four copies of the user data are spread across the first and second RUs. As such, while the data rate for transmission of each copy of the user data using the DUP mode may be the same as a data rate for a transmission using a “normal” mode, the transmit power for the transmission using the EHT DUP mode may be essentially multiplied by the number of copies of the data being transmitted, at the expense of requiring an increased bandwidth. As such, using the EHT DUP mode may reduce spectrum efficiency.

Various aspects generally relate to distributed tone transmissions by wireless communication devices of a wireless communication system that includes multiple BSSs, and more specifically to STAs in different BSSs using distributed RUs of a same channel using a distributed tone plan. In some examples, the wireless communication devices may implement a coordinated distributed tone plan in which a wireless communication device (for example, a wireless AP) assigns distributed RUs to one or more STAs in its BSS and one or more STAs in each of one or more other different BSSs. In some other examples, the wireless communication devices may implement an uncoordinated distributed tone plan in which a wireless communication device indicates, to another wireless communication device, the distributed RUs that the wireless communication device is using, which may be referred to as occupied distributed RUs (for example, where tones of the occupied distributed RUs carry data for a data field) and conditions (such as permission information) that are to be satisfied by other STAs and/or APs before such STAs or APs may opportunistically transmit via the unoccupied distributed RUs. For a coordinated distributed tone plan transmission, a wireless AP may transmit a control message assigning distributed RUs to one or more STAs. In some implementations, the control message may trigger communications to or from the wireless AP at the one or more STAs using the distributed RUs. For an uncoordinated transmission, a first wireless communication device (for example, an AP or a non-AP STA) may perform a transmission using one or more occupied distributed RUs. The transmission may include a preamble indicating the occupied distributed RUs and one or more conditions for a second wireless communication device (for example, another AP or non-AP STA) to use unoccupied distributed units for the duration of the transmission, which may be or include a transmission opportunity (TXOP). In this way, the first wireless communication device may transmit or receive communications to or from other wireless communication devices using the occupied distributed RUs, while the second wireless communication device may transmit or receive communications to or from other wireless communication devices using the distributed RUs unoccupied by the first wireless communication device for at least part of the duration of the transmissions at the first wireless communication device.

Particular aspects of the subject matter described in this disclosure may be implemented to realize one or more of the following potential advantages. Various implementations of the techniques described herein may result in improved, or preserved, spectral efficiency associated with multiplexing transmissions from multiple STAs by increasing the transmit power for each STA by distributing tones across a spreading bandwidth in a PSD-limited band. In contrast, using the DUP mode may provide for a transmission power increase, but may sacrifice spectral efficiency.

Aspects of the disclosure are initially described in the context of a wireless communication system. Aspects of the disclosure also are described in the context of resource diagrams and process flows. Aspects of the disclosure are further illustrated by and described with reference to apparatus diagrams, system diagrams, and flowcharts that relate to distributed tone transmission in a multiple BSS network topology.

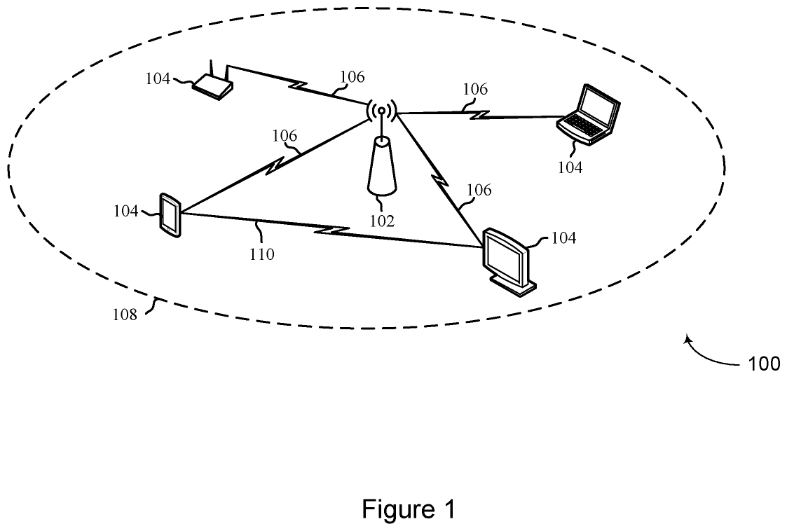

FIG. 1 shows a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a BSS, which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHZ or 6 GHZ bands, each of which is divided into multiple 20 MHz channels. As such, these PPDUs are transmitted over a physical channel having a minimum bandwidth of 20 MHZ, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

A STA 104 (for example, an AP 102 or a non-AP STA) may transmit a message to one or more STAs 104 in a multiple BSS system that indicates one or more distributed RUs for the STAs 104 to use for communications, in which each distributed RU includes a respective set of tones interspersed within a channel bandwidth such that tones of STAs 104 in different BSSs are interleaved. For example, a coordinating STA 104 may indicate respective distributed RUs assigned to each BSS, and may communicate with the STAs 104 using tones of the distributed RUs for the BSS supported by the coordinating STA 104. In some other examples, a STA 104 may indicate occupied distributed RUs and a permission condition to another STA 104, such that the other STA 104 may use unoccupied distributed RUs for communications in accordance with the permission condition.

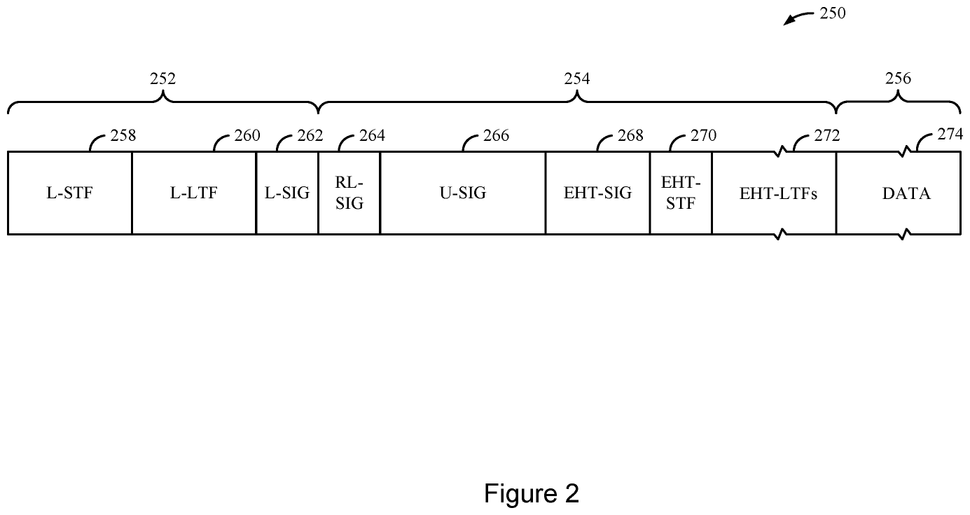

FIG. 2 shows another example PPDU CCC50 usable for wireless communication between a wireless AP and one or more wireless STAs. The PPDU CCC50 may be used for SU, OFDMA or MU-MIMO transmissions. The PPDU CCC50 may be formatted as an Extremely High Throughput (EHT) WLAN PPDU in accordance with the IEEE 802.11be amendment to the IEEE 802.11 family of wireless communication protocol standards, or may be formatted as a PPDU conforming to any later (post-EHT) version of a new wireless communication protocol conforming to a future IEEE 802.11 wireless communication protocol standard, such as the 802.11 amendment associated with Wi-Fi 8), or another wireless communication standard. The PPDU CCC50 includes a PHY preamble including a legacy portion CCC52 and a non-legacy portion CCC54. The PPDU CCC50 may further include a PHY payload CCC56 after the preamble, for example, in the form of a PSDU including a data field CCC74.

The legacy portion CCC52 of the preamble includes an L-STF CCC58, an L-LTF CCC60, and an L-SIG CCC62. The non-legacy portion CCC54 of the preamble includes a repetition of L-SIG (RL-SIG) CCC64 and multiple wireless communication protocol version-dependent signal fields after RL-SIG CCC64. For example, the non-legacy portion CCC54 may include a universal signal field CCC66 (referred to herein as “U-SIG CCC66”) and an EHT signal field CCC68 (referred to herein as “EHT-SIG CCC68”). The presence of RL-SIG CCC64 and U-SIG CCC66 may indicate to EHT- or later version-compliant STAs 104 that the PPDU CCC50 is an EHT PPDU or a PPDU conforming to any later (post-EHT) version of a new wireless communication protocol conforming to a future IEEE 802.11 wireless communication protocol standard. One or both of U-SIG CCC66 and EHT-SIG CCC68 may be structured as, and carry version-dependent information for, other wireless communication protocol versions associated with amendments to the IEEE family of standards beyond EHT. For example, U-SIG CCC66 may be used by a receiving device to interpret bits in one or more of EHT-SIG CCC68 or the data field CCC74. Like L-STF CCC58, L-LTF CCC60, and L-SIG CCC62, the information in U-SIG CCC66 and EHT-SIG CCC68 may be duplicated and transmitted in each of the component 20 MHz channels in instances involving the use of a bonded channel.

The non-legacy portion CCC54 further includes an additional short training field CCC70 (referred to herein as “EHT-STF CCC70,” although it may be structured as, and carry version-dependent information for, other wireless communication protocol versions beyond EHT) and one or more additional long training fields CCC72 (referred to herein as “EHT-LTFs CCC72,” although they may be structured as, and carry version-dependent information for, other wireless communication protocol versions beyond EHT). EHT-STF CCC70 may be used for timing and frequency tracking and AGC, and EHT-LTF CCC72 may be used for more refined channel estimation.

EHT-SIG CCC68 may be used by an AP to identify and inform one or multiple STAs 104 that the AP has scheduled UL or DL resources for them. EHT-SIG CCC68 may be decoded by each compatible STA 104 served by the AP 102. EHT-SIG CCC68 may generally be used by a receiving device to interpret bits in the data field CCC74. For example, EHT-SIG CCC68 may include RU allocation information, spatial stream configuration information, and per-user (for example, STA-specific) signaling information. Each EHT-SIG CCC68 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field CCC74.

In some wireless communications environments, Extremely High Throughput (EHT) systems or other systems compliant with future generations of the IEEE 802.11 family of wireless communication protocol standards may provide additional capabilities over other previous systems (for example, High Efficiency (HE) systems or other legacy systems). EHT and newer wireless communication protocols may support flexible operating bandwidth enhancements at APs and STAs, such as broadened operating bandwidths relative to legacy operating bandwidths or more granular operation relative to legacy operation. For example, an EHT system may allow communications spanning operating bandwidths of 20 MHZ, 40 MHZ, 80 MHZ, 160 MHz, 240 MHz and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device operates in a contiguous 320 MHz bandwidth mode or a 160+160 MHz bandwidth mode. Signals for transmission may be generated by two different transmit chains of the device each having a bandwidth of 160 MHZ (and each coupled to a different power amplifier). In some other examples, signals for transmission may be generated by four or more different transmit chains of the device, each having a bandwidth of 80 MHZ.

In some other examples, the wireless communication device may operate in a contiguous 240 MHz bandwidth mode, or a noncontiguous 160+80 MHz bandwidth mode. In some examples, the signals for transmission may be generated by three different transmit chains of the device, each having a bandwidth of 80 MHz. In some other examples, the 240 MHz/160+80 MHz bandwidth modes may also be formed by puncturing 320/160+160 MHz bandwidth modes with one or more 80 MHZ subchannels. For example, signals for transmission may be generated by two different transmit chains of the device each having a bandwidth of 160 MHz with one of the transmit chains outputting a signal having an 80 MHz subchannel punctured therein.

The operating bandwidth also may accommodate concurrent operation on other unlicensed frequency bands (such as the 6 GHz band) and a portion of spectrum that includes frequency bands traditionally used by Wi-Fi technology. In noncontiguous examples, the operating bandwidth may span one or more disparate sub-channel sets. For example, the 320 MHz bandwidth may be contiguous and located in the same 6 GHz band or noncontiguous and located in different bands (such as partly in the 5 GHZ band and partly in the 6 GHz band).

In some examples, operability enhancements associated with EHT and newer generations of the IEEE 802.11 family of wireless communication protocols, and in particular operation at an increased bandwidth, may include refinements to carrier sensing and signal reporting mechanisms. Such techniques may include modifications to existing rules, structure, or signaling implemented for legacy systems.

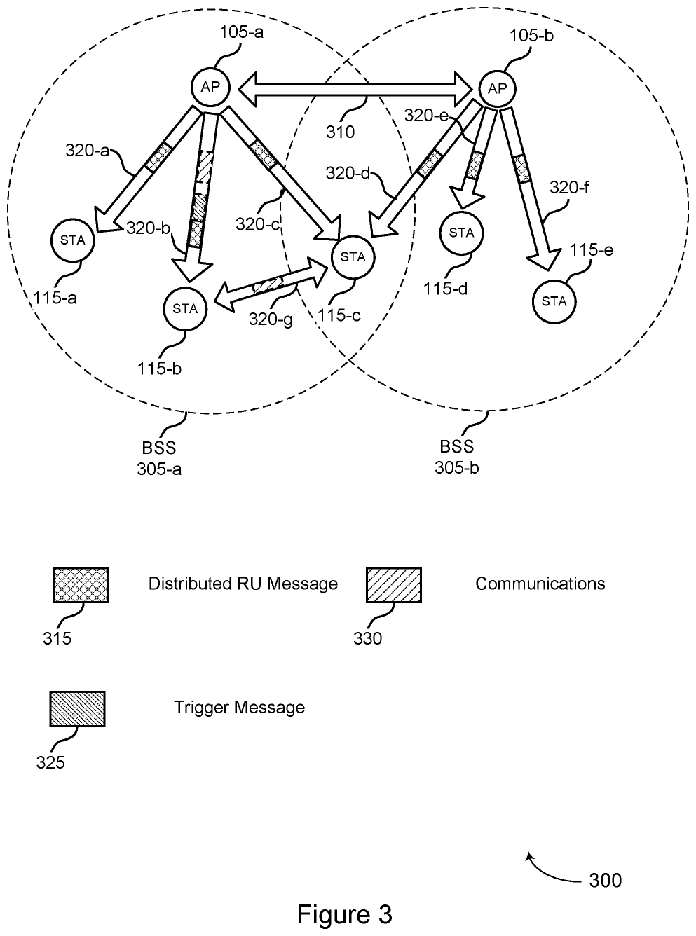

FIG. 3 illustrates an example of a wireless communication network 300 that supports distributed tone transmission in a multiple BSS network topology in accordance with one or more aspects of the present disclosure. In some examples, the wireless communication network 300 may implement aspects of the wireless communication network 100 and the PHY PPDU in FIG. 2. The wireless communication network 300 illustrates communications between one or more APs, such as an AP 105-a and an AP 105-b, and/or one or more STAs, such as a STA 115-a through a STA 115-c. The AP 105-a and the AP 105-b may be examples of APs 102 described with reference to FIG. 1. The STA 115-a through the STA 115-e may be examples of STAs 104 described with reference to FIG. 1.

In some examples, the wireless communication network 300 may implement a multiple BSS network topology. For example, the wireless communication network 300 may include a BSS 305-a and a BSS 305-b, in which each BSS may include at least an AP and one or more STAs. For example, the BSS 305-a may include the AP 105-a, the STA 115-a, the STA 115-b, and the STA 115-c. Similarly, the BSS 305-b may include the AP 105-b, the STA 115-a, the STA 115-b, and the STA 115-c. A BSS may include any number of STAs, and a STA may belong to one or more BSSs. For example, the STA 115-c may be a part of the BSS 305-a and/or the BSS 305-b. In some examples, the APs from different BSSs may be in communication, which may be referred to as an extended service set (ESS). For example, the AP 105-a and the AP 105-b may be connected via a link 310, which may be a wired or wireless link. In some implementations, there may be a coordinating, or controlling, AP for the ESS, such that the coordinating AP may transmit scheduling information or other control information to other APs of other BSSs.

In some implementations, STAs, APs, or both may communicate with each other using one or more channels, which may be referred to as Wi-Fi channels. For example, the STAs, APs, or both may communicate with one another via a channel in a 2.4 GHz band, a channel in a 5 GHz band, a channel in a 6 GHz band, or any combination. The 2.4, 5, and 6 GHz bands may generally be referred to as “sub 7” bands. The communication channels may have a power spectral density (PSD) maximum and a transmit power maximum, in which PSD is a measure of signal strength variations across the communication channel as a function of frequency. For example, the 6 GHz band, a low power indoor (LPI) channel, and a very low power (VLP) channel may have a relatively low PSD maximum and relatively low transmit power maximum. Specifically, the LPI channel may have a 5 decibel-milliwatts (dBm)/megahertz (MHz) maximum for an AP and −1 dBm/MHz for a STA.

To overcome, or extend, the PSD maximum, the APs, the STAs, or both may implement an EHT DUP mode for a transmission, in which transmitted data in a payload portion of a PPDU is duplicated in the frequency domain. The APs, the STAs, or both may use a value for modulation and coding scheme (MCS) specific to the EHT DUP mode, such as an MCS of 14. However, using an EHT DUP mode may reduce spectrum efficiency, among other drawbacks (for example, such as reducing spectrum efficiency to ¼th of the MCS). Thus, the APs, the STAs, or both may implement a distributed tone plan to overcome, or extend, the PSD maximum while maintaining or improving spectrum efficiency. For example, one or more STAs and/or APs may communicate using a distributed tone plan, in which the tones from each STA are interleaved. Using the distributed tone plan for communications in a channel with a PSD maximum may increase transmit power for each STA due to an increased bandwidth spread, may result in power pooling gain from multiple STAs and/or APs communicating simultaneously, may improve spectrum efficiency due to less duplication (for example, each STA occupies a subset of tones within the PPDU bandwidth), among other benefits. However, the wireless communication devices (for example, STAs and APs) in a wireless communication system with multiple BSSs may be unable to implement a distributed tone plan across the different BSSs.

In some examples, the wireless communication devices in the wireless communication network 300 may use one or more distributed RUs for communications, in which each distributed RU includes a respective set of tones interspersed within a channel bandwidth such that tones of STAs in different BSSs are interleaved. For example, the wireless communication network 300 may illustrate an example of wireless communication devices implementing a coordinated distributed tone plan to communicate with each other. In some examples, a coordinating STA may assign the distributed RUs to multiple STAs in different BSSs. For example, the AP 105-a may assign one or more distributed RUs to the STA 115-a, the STA 115-b, and the STA 115-c in the BSS 305-a. The AP 105-a may indicate the distributed RUs in a distributed RU message 315 via a link 320-a, a link 320-b, and a link 320-c, respectively. In some examples, the AP 105-a may be in communication with the AP 105-b, and may indicate the distributed RUs for the STA 115-c, the STA 115-d, and the STA 115-e in the BSS 305-b. Additionally, or alternatively, the AP 105-b may otherwise determine the distributed RUs for the STAs in the BSS 305-b. The AP 105-b may assign the distributed RUs to the STA 115-c, the STA 115-d, and the STA 115-e in a distributed RU message 315 via a link 320-d, a link 320-c, and a link 320-f, respectively.

In some examples, the AP 105-a, the AP 105-b, or both may broadcast the distributed RU message 315 to the STAs in the BSS 305-a and the BSS 305-b. In some other examples, the AP 105-a, the AP 105-b, or both may assign the distributed RUs in separate distributed RU messages 315 to each STA in the BSS 305-a and the BSS 305-b. The AP 105-a, the AP 105-b, or both may include the distributed RU message 315 with control signaling, such as scheduling grants or other control signaling. In some other implementations, the AP 105-a, the AP 105-b, or both may include the distributed RU message 315 in a control message separate from other control signaling (for example, a dedicated control message).

In some implementations, the coordinating STA, such as the AP 105-a, may send a trigger message 325 to trigger communications 330 at one or more STAs. For example, the AP 105-a may send a trigger message 325 to STA 115-b. The trigger message may trigger the communications 330 between the AP 105-a and the STA 115-b, and/or between the STA 115-b and another STA (for example, the STA 115-c via a link 320-g). For example, the trigger message may implicitly or explicitly indicate for the STA 115-b to receive a message from the AP 105-a, to transmit a message to the STA 115-c, or both, using a set of tones of the distributed RUs assigned to the STA 115-b in the BSS 305-a (for example, via the distributed RU message 315). The communications 330 may be OFDMA communications. In some examples, the AP 105-a may transmit the trigger message 325 in a same packet as the distributed RU message 315. In some other examples, the AP 105-a may transmit the trigger message 325 in a different packet than the distributed RU message 315. The STA 115-b may synchronize the communications 330 in the time domain and/or the frequency domain using the trigger message 325 (for example, a trigger frame indicated by the trigger message 325) to provide for orthogonality of the communications 330. That is, the trigger message 325 may trigger the communications 330 such that transmissions by STAs in various BSSs are synchronized in the time domain and/or the frequency domain. For example, the communications 330 at the STA 115-b in the BSS 305-a may be synchronized in time and frequency with communications to and/or from the AP 105-b in the BSS 305-b.

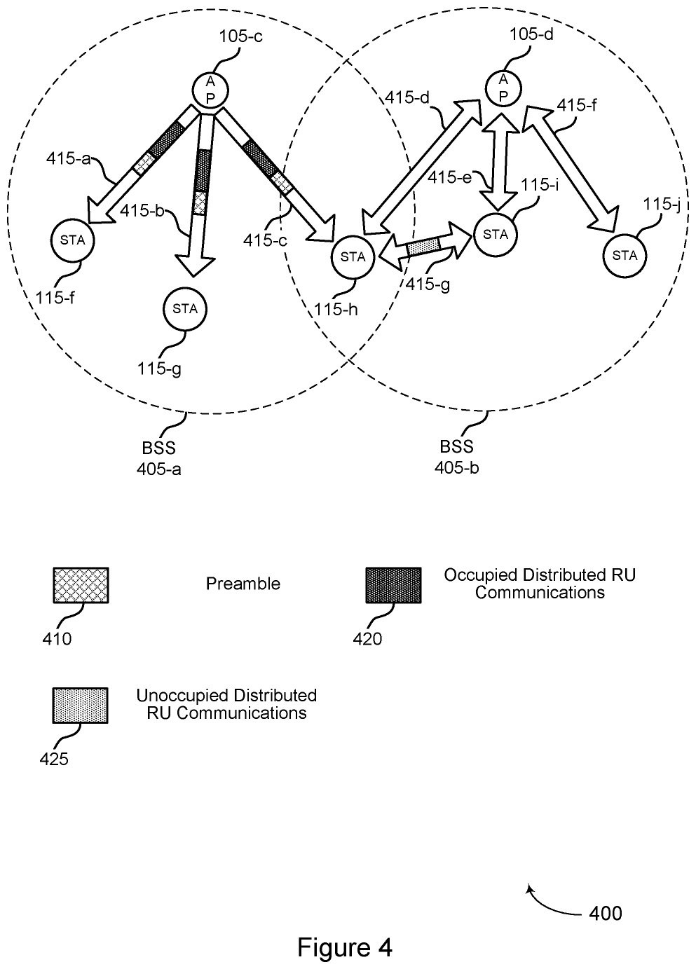

FIG. 4 illustrates an example of a wireless communication system 400 that supports distributed tone transmission in a multiple BSS network topology in accordance with one or more aspects of the present disclosure. In some examples, the wireless communication system 400 may implement aspects of the wireless communication network 100 and the PHY PPDU in FIG. 2. The wireless communication network 400 illustrates communications between one or more APs, such as an AP 105-c and an AP 105-d, and one or more STAs, such as a STA 115-f through a STA 115-j. The AP 105-c and the AP 105-d may be examples of APs 102 described with reference to FIG. 1. The STA 115-f through the STA 115-j may be examples of STAs 104 described with reference to FIG. 1.

In some examples, the wireless communication devices in the wireless communication network 400 may use one or more distributed RUs for communications, in which each distributed RU includes a respective set of tones interspersed within a channel bandwidth such that tones of STAs in different BSSs are interleaved. For example, the AP 105-c may communicate with one or more STAs in the BSS 405-a, such as the STA 115-f, the STA 115-g, and/or the STA 115-h. Similarly, the AP 105-d may communicate with one or more STAs in the BSS 405-b, such as the STA 115-h, the STA 115-i, and/or the STA 115-j.

In some implementations, the wireless communication network 400 may illustrate an example of wireless communication devices implementing an uncoordinated distributed tone plan to communicate with each other. In some examples, a wireless communication device (for example, a STA or AP) may initiate a distributed tone RU transmission with another wireless communication device. For example, an AP 105-c (or another wireless communication device) may initiate a distributed tone RU transmission with a STA in a BSS 405-a, such as the STA 115-f, the STA 115-g, and/or the STA 115-h. In some other examples, a non-AP STA may initiate a distributed tone RU transmission with another STA in the BSS 405-a, such as for communications between the STA 115-f, the STA 115-g, and/or the STA 115-h. In some implementations, the wireless communication device that initiates the distributed tone RU transmission (for example, the AP 105-c, or a non-AP STA) may announce one or more occupied distributed RUs in the preamble 410 of a transmission, in which the occupied distributed RUs may be the distributed RUs the wireless communication device is using for the transmission. For example, the AP 105-c may broadcast, or otherwise announce, the occupied distributed resources in the preamble 410 to the STA 115-f via the link 415-a, to the STA 115-g via the link 415-b, to the STA 115-h via the link 415-c, or any combination thereof. Similarly, the AP 105-d or another STA in the BSS 405-b may broadcast, or otherwise announce, the occupied distributed resources to the STAs in the BSS 405-b, such as the STA 115-h via a link 415-d, the STA 115-i via a link 415-c, and/or the STA 115-j via a link 415-f. In some examples, the preamble 410 may also include a resource condition (for example, a permission condition) for the wireless communication device receiving the preamble 410. For example, the AP 105-c may indicate in the preamble 410 that the STA 115-h may use the unoccupied distributed RUs of the BSS 405-a for communications.

In some examples, the wireless communication device initiating the distributed tone RU transmission may send or receive occupied distributed RU communications 420. For example, the AP 105-c may transmit signaling to the STA 115-g using one or more tones of the occupied distributed RUs that the AP 105-c indicated in the preamble 410. In some other examples, a STA may be initiating the distributed tone RU transmission, and the STA may send one or more tones of the occupied distributed RUs that the STA indicated in a preamble of the transmission.

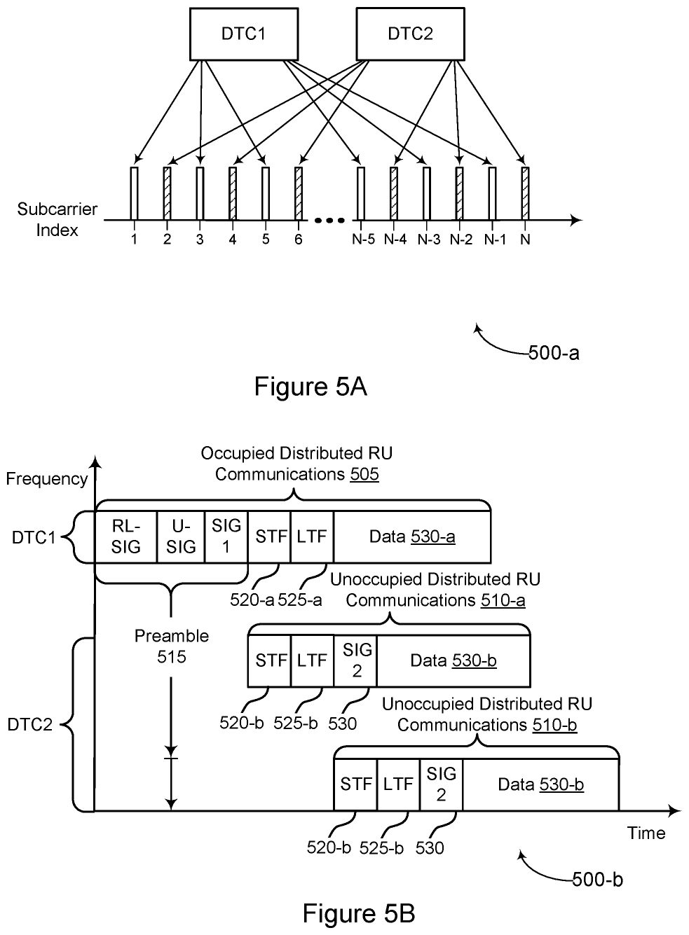

In some implementations, the STA 115-h may be in the BSS 405-a and the BSS 405-b. The STA 115-h may perform unoccupied distributed RU communications 425 after decoding the preamble 410 of a transmission using the occupied distributed RUs. For example, the STA 115-h may perform the unoccupied distributed RU communications 425 for the remaining time of a PPDU allocated for the transmission from the AP 105-c. The unoccupied distributed RU communications 425 may include a transmission from the STA 115-h to the STA 115-i in the BSS 405-b and via the link 415-g. In some implementations, the STA 115-h may dynamically select which unoccupied distributed RUs to use for the transmission. In some other implementations, the STA 115-h may use a defined distributed tone channel (DTC) plan, which is described in further detail with respect to FIG. 5A.

In some examples, the preamble 410 for a transmission between the AP 105-c and the STA 115-g may serve as a trigger frame for communications between the STA 115-h and the STA 115-i. For example, the STA 115-h and the STA 115-i may both receive the preamble 410 by listening to the transmission between the AP 105-c and the STA 115-g. The STA 115-h and the STA 115-i may synchronize (for example, pre-correct) communications in the time domain and the frequency domain with the communications between the AP 105-c and the STA 115-g from decoding the preamble 410. The STA 115-h may obtain an indication of unoccupied distributed RUs or DTC information, and an indication of a resource condition for the STA 115-h (for example, whether the STA 115-h has permission to use the unoccupied distributed RUs, a DTC, or both). The STA 115-h may align the timing and frequency for the unoccupied distributed RU communications 425 with the occupied distributed RU communications 420, which is described in further detail with respect to FIG. 5B. For example, to maintain orthogonality for the occupied distributed RU communications 420 and the unoccupied distributed RU communications 425, the STA 115-h may align an OFDM symbol boundary of the unoccupied distributed RU communications 425 with the occupied distributed RU communications 420.

In some examples, the STA 115-g may have an automatic gain control (AGC) setting, which may be an algorithm used to regulate a received signal strength for successful decoding. The STA 115-g may determine whether the occupied distributed RU communications 420 from the AP 105-c pass the AGC setting prior to the STA 115-h transmitting the unoccupied distributed RU communications 425 to the STA 115-i. For example, in examples in which the unoccupied distributed RU communications are started after the short training field (STF) of the occupied distributed RU communications 420, then the occupied distributed RU communications 420 may have already passed the AGC setting. In examples in which the unoccupied distributed RU communications 425 cut in to the PPDU for the occupied distributed RU communications, the STA 115-g may see a sudden power change. Thus, the STA 115-h may control the power from the unoccupied distributed RU communications 425 to be within a tolerable range of the AGC setting of the STA 115-g, such as to reduce, or prevent, interference from the unoccupied distributed RU communications 425 at the occupied distributed RU communications 420.

For example, the AP 105-c, the AP 105-d, and/or the STA 115-h may determine a power threshold value for the unoccupied distributed RU communications 425, and the STA 115-h may perform the unoccupied distributed RU communications 425 such that a transmit power stays below the power threshold value. In some implementations, the AP 105-c and/or the AP 105-d may indicate the power threshold value to the STA 115-h via the link 415-c or the link 415-d, respectively. In some other implementations, the STA 115-h may determine the power threshold value independent of the AP 105-c and the AP 105-d. In some implementations, the unoccupied distributed RU communications 425 may satisfy an un-used tone error vector magnitude (EVM) condition to reduce, or prevent, the interference for the occupied distributed RU communications 420.

In some examples, the frequency resource allocation (for example, RU or DTC allocation) for the STA 115-h to use for the unoccupied distributed RU communications may be static, such that the STA 115-h may timely use a remaining RU or DTC of the PPDU for the occupied distributed RU communications 420. A static frequency resource allocation may prevent collision issues due to multiple STAs competing for the same resources (for example, unoccupied distributed RUs) and/or delays due to the STAs reading parameters from the occupied distributed RUs to obtain the available, or unoccupied, frequency resource allocation.

FIGS. 5A and 5B illustrate examples of a resource diagram 500-a and a resource diagram 500-b that support distributed tone transmission in a multiple BSS network topology in accordance with one or more aspects of the present disclosure. In some examples, the resource diagram 500-a and the resource diagram 500-b may implement or may be implemented by aspects of the wireless communication network 100 and the wireless communication network 500 as described with reference to FIGS. 1 and 4, as well as the PHY PPDU of FIG. 2. For example, the resource diagram 500-a and the resource diagram 500-b may be implemented by a wireless communication system in which STAs (for example, an AP STA or a non-AP STA) use an uncoordinated distributed tone plan to communicate with each other.

In some examples, as illustrated in FIG. 5A, a STA may perform a transmission using a PPDU in accordance with a DTC plan. For example, the STA may use one of two DTCs, such as one of DTC1 or DTC2 that span a channel bandwidth (for example, 160 MHZ). Another STA may use the other of the two DTCs. Each DTC may have a spreading bandwidth equal to the channel bandwidth, and STAs may interleave tones over the DTCs. In some implementations, a coordinating STA of a BSS may select a DTC, such that each DTC is assigned to a different BSS. In some examples, the DTC plan for the STAs to interleave the tones over the DTCs may include a first STA of a first BSS transmitting using odd subcarrier indices of the channel bandwidth using DTC1 (for example, subcarrier index 1, 3, 5, N−5, N−3, N−1) and a second STA of a second BSS transmitting using even subcarrier indices of the channel bandwidth using DTC2 (for example, subcarrier index 2, 4, 6, N−4, N−2, and N).

In some examples, a STA may use one or more distributed RUs of a PPDU for a transmission, and may indicate one or more remaining distributed RUs to other STAs in a preamble of the transmission (e.g., a preamble 515), as described with reference to FIG. 4. For example, the STA may use occupied distributed RUs for the transmission (for example, occupied distributed RU communications 505) and another STA may use the unoccupied distributed RUs for another transmission (for example, unoccupied distributed RU communications 510-a or unoccupied distributed RU communications 510-b). The other STA may align the timing for unoccupied distributed RU communications 510-a or the timing for unoccupied distributed RU communications 510-b with the occupied distributed RU communications 505. That is, the STA performing the unoccupied distributed RU communications 510-a or the unoccupied distributed RU communicants 510-b may determine a cut-in location in the time domain to begin the unoccupied distributed RU communications 510-a or a cut-in location in the time domain to begin the unoccupied distributed RU communications 510-b.

In some examples, the occupied distributed RU communications 505 may include a repeated legacy signal (RL-SIG) field, a universal signal (U-SIG) field, and a first signal (SIG1) field in the preamble 515 of the transmissions. The preamble 515 may serve as a trigger frame for the unoccupied distributed RU communications 510-a or the unoccupied distributed RU communications 510-b. The trigger may be the preamble 515 of the occupied distributed RU communications 505, and may trigger the transmission of the unoccupied distributed RU communications 510-a or the unoccupied distributed RU communications 510-b. In some implementations, the occupied distributed RU communications 505 may also include a STF 520-a, a long training field (LTF) 525-a, and data 530-a. Similarly, the unoccupied distributed RU communications 510-a and the unoccupied distributed RU communications 510-b may include an STF 520-b, an LTF 525-b, a second signal (SIG2) field, and data 530-b. An STF field may be an ultra-high reliability (UHR)-STF, and a STA may use the STF to identify a new transmission. Similarly, the LTF field may be an UHR-LTF, which a STA may use for channel estimation. For example, a STA transmitting the unoccupied distributed RU communications 510-a or the unoccupied distributed RU communications 510-b may use the LTF 525-b for channel estimations of a following SIG2 530 and data 530-b. In some examples, the SIG2 530 may carry parameters for data demodulation (an MCS, a number of spatial streams, coding information, etc.). In examples in which the number of spatial streams is greater than 1, the STA may send additional LTFs between the SIG2 530 and the data 530-b.

In some implementations, a STA may align the cut-in time of the unoccupied distributed RU communications 510-a with the STF 520-a of the ongoing occupied distributed RU communications 505. Aligning the unoccupied distributed RU communications 510-a with the STF 520-a of the ongoing occupied distributed RU communications 505 may prevent, or avoid, an incorrect AGC setting in receiving the packet via the occupied distributed RU, which may occur in examples in which the STA performs the unoccupied distributed RU communications 510-a after a STF measurement of the occupied distributed RU communications 505. In some other implementations, the STA may align the cut-in time of the unoccupied distributed RU communications 510-b with a later time than the STF 520-a, such as with a first data symbol of the occupied distributed RU communications 505. The STA may determine the cut-in time based on decoding the preamble 515. For example, the preamble 515 may explicitly indicate the cut-in time, or the STA may implicitly determine the cut-in time based on the decoding processing of the preamble 515, one or more parameters in the preamble 515, or among other examples. In some implementations, the STA may perform the unoccupied distributed RU communications 510-a or the unoccupied distributed RU communications 510-b in accordance with a greenfield PPDU format due to the triggering from the preamble 515.

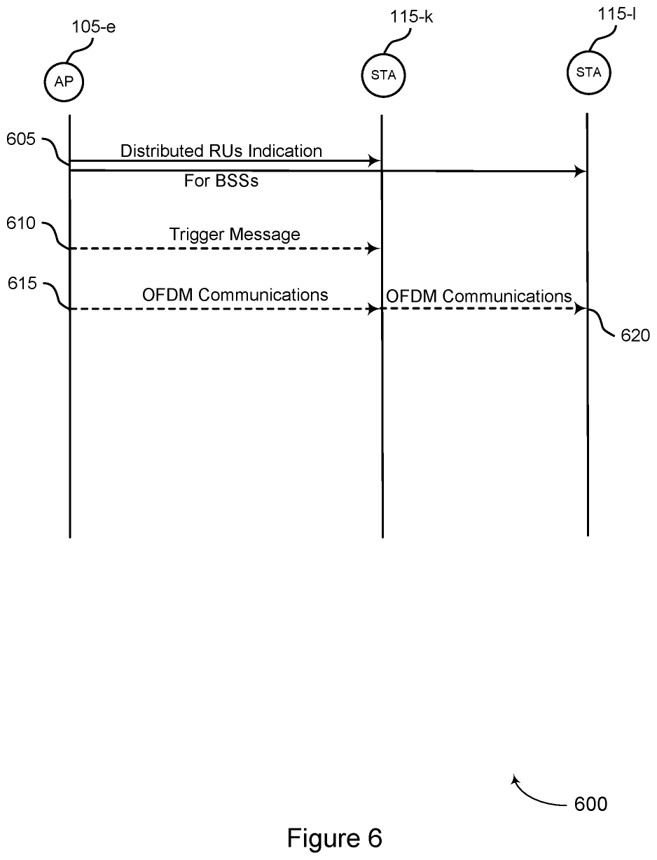

FIG. 6 illustrates an example of a process flow 600 that supports distributed tone transmission in a multiple BSS network topology in accordance with one or more aspects of the present disclosure. The process flow 600 may implement or may be implemented by aspects of wireless communication network 100 and/or the wireless communication network 400 as described with reference to FIGS. 1 and 4. For example, the process flow 600 illustrates communications between a coordinating STA (for example, an AP 105-e or a non-AP STA) and one or more other STAs (for example, a STA 115-k and/or a STA 115-1), which may represent aspects of corresponding devices as described with reference to FIGS. 1 and 3. In some examples, the AP 105-e, the STA 115-k, and the STA 115-1 may use a coordinated distributed tone plan to communicate with each other over multiple BSSs.

In the following description of the process flow 600, the operations between the AP 105-c, the STA 115-k, and the STA 115-1 may be performed in different orders or at different times. Some operations may also be left out of the process flow 600, or other operations may be added. Although the AP 105-c, the STA 115-k, and the STA 115-1 are shown performing the operations of the process flow 600, some aspects of some operations may also be performed by one or more other wireless communication devices. For example, the actions performed by the AP 105-e may additionally, or alternatively, be performed by a non-AP STA.

In some examples, the STA 115-k and the STA 115-1 may belong to different BSSs. The AP 105-e may be a coordinating AP, and may be in communication with the AP for both BSSs and/or may be the AP for both BSSs.

At 605, the AP 105-e (for example, coordinating AP) may transmit a message to multiple STAs, including the STA 115-k and the STA 115-1, indicating respective distributed RUs assigned to each BSS. In some implementations, each distributed RU may include a respective set of tones interspersed within a channel bandwidth such that tones of the respective set of tones are interleaved with tones of at least one distributed RU assigned to at least one other BSS. For example, the AP 105-e may interleave tones with tones from the STA 115-k to a STA in a different BSS than the AP 105-e. The AP 105-e may transmit the message after determining that at least one STA of the multiple STAs is operating in a channel that satisfies a PSD threshold value.

At 610, the AP 105-e may transmit a second message to trigger OFDMA communications by the STA 115-k using the respective sets of tones of the respective distributed RUs assigned to the respective BSSs of the STA 115-k and the STA 115-1. For example, in examples in which the second message triggers OFDMA communications from the STA 115-k to the STA 115-1, and the STA 115-1 belongs to a different BSS than the AP 105-e, then the OFDMA communications from the STA 115-k may use sets of tones of respective distributed RUs assigned to the different BSS. In some implementations, the first message and the second message are both transmitted in a same packet. In some other implementations, the first message and the second message are transmitted in different respective packets. In some examples, the second message may trigger communications at one or more wireless STAs to synchronize communications across BSSs in a time domain and a frequency domain.

At 615, the AP 105-e may communicate with one or more STAs, such as the STA 115-k, using the respective set of tones of the one or more respective distributed RUs assigned to the BSS of the STA 115-k and the AP 105-e.

At 620, the STA 115-k may communicate with one or more STAs, such as the STA 115-1, using the respective set of tones of the one or more respective distributed RUs assigned to the BSS of the STA 115-k and the STA 115-1.

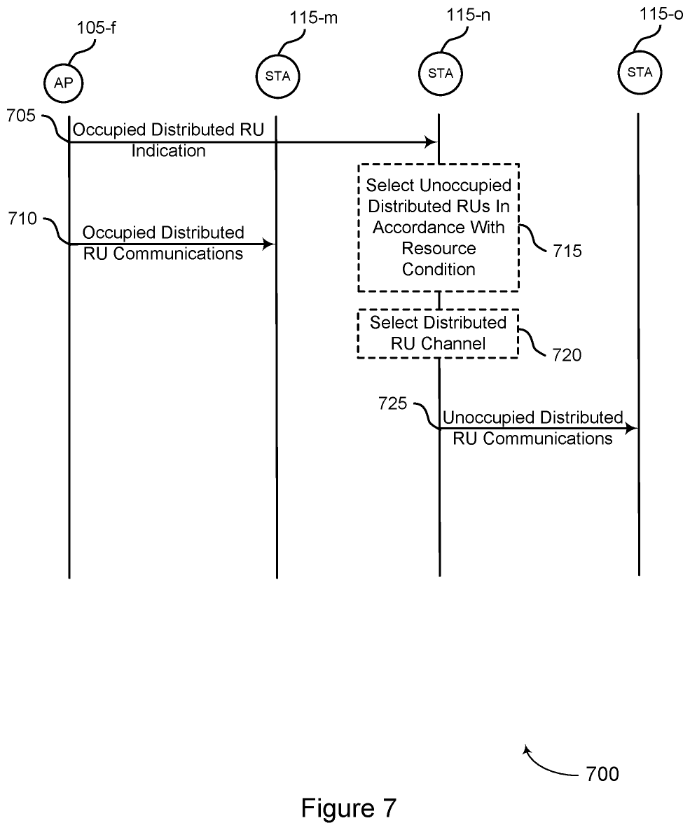

FIG. 7 illustrates an example of a process flow 700 that supports distributed tone transmission in a multiple BSS network topology in accordance with one or more aspects of the present disclosure. The process flow 700 may implement or may be implemented by aspects of wireless communication network 100, the PHY PPDU of FIG. 2, the wireless communication network 400, the resource diagram 500-a, and/or the resource diagram 500-b, as described with reference to FIGS. 1, 2, 4, 5A, and 5B. For example, the process flow 700 illustrates communications between a coordinating STA (for example, an AP 105-f or a non-AP STA) and one or more other STAs (for example, a STA 115-m, a STA 115-n, and/or a STA 115-0), which may represent aspects of corresponding devices as described with reference to FIGS. 1 and 4. In some examples, the AP 105-f, the STA 115-m, the STA 115-n, and the STA 115-o may use an uncoordinated distributed tone plan to communicate with each other over multiple BSSs.

In the following description of the process flow 700, the operations between the AP 105-f, the STA 115-m, the STA 115-n, and the STA 115-o may be performed in different orders or at different times. Some operations may also be left out of the process flow 700, or other operations may be added. Although the AP 105-f, the STA 115-m, the STA 115-n, and the STA 115-o are shown performing the operations of the process flow 700, some aspects of some operations may also be performed by one or more other wireless communication devices. For example, the actions performed by the AP 105-f may additionally, or alternatively, be performed by a non-AP STA.

In some examples, the STA 115-m, the STA 115-n, and/or the STA 115-0 may belong to different BSSs.

At 705, the AP 105-f may transmit an indication of one or more occupied distributed RUs to the STA 115-n and an indication of a resource condition for the STA 115-n in a preamble of a transmission that occupies the one or more distributed RUs. In some implementations, each distributed RU may include a respective set of tones interspersed within a channel bandwidth such that tones of the respective set of tones are interleaved with tones of at least one distributed RU assigned to at least one other BSS.

At 710, the AP 105-f may exchange occupied distributed RU communications with the STA 115-m. For example, the AP 105-f may transmit data to the STA 115-m for a duration, may receive data from the STA 115-m for a duration, or both using respective tones of the occupied distributed RUs.

At 715, the STA 115-n may select one or more unoccupied distributed RUs in accordance with the resource condition indicating for the wireless station to communicate using the one or more unoccupied distributed RUs. For example, the resource condition for the STA 115-n may indicate whether the STA 115-n is permitted to use the unoccupied distributed RUs.

At 720, the STA 115-n may select a distributed RU channel (for example, DTC) for communicating that is different than a distributed RU channel the AP 105-f uses for the occupied distributed RU communications.

At 725, the STA 115-n and the STA 115-o may communicate using a respective set of tones of the one or more unoccupied distributed resource units in accordance with the resource condition and for the duration. For example, the STA 115-n may align a time domain symbol boundary of the communications within the duration of the transmission. In some examples, the communicating is in accordance with an STF (for example, UHR-STF), an LTF (for example, UHR-LTF), a signal field indicating one or more parameters for data demodulation, or any combination thereof. In some implementations, the communicating may satisfy a power threshold value for the STA 115-m, the STA 115-n, or both. Additionally, or alternatively, the communicating may satisfy an interference threshold value for the STA 115-m, the STA 115-n, or both.

In some implementations, the preamble may trigger communications between the STA 115-n and the STA 115-o to synchronize the communications with the occupied distributed RU communications in a time domain and a frequency domain. For example, the preamble may be configured to align a start of the unoccupied distributed RU communications (for example, a transmission between the STA 115-n and the STA 115-0) with an STF of the preamble of the occupied distributed RU communications. In some other examples, the preamble may be configured to align a start of the unoccupied distributed RU communications with an initial data symbol of the preamble of the occupied distributed RU communications.

In some examples, the occupied distributed RU communications and/or the unoccupied distributed RU communications may be OFDMA communications.

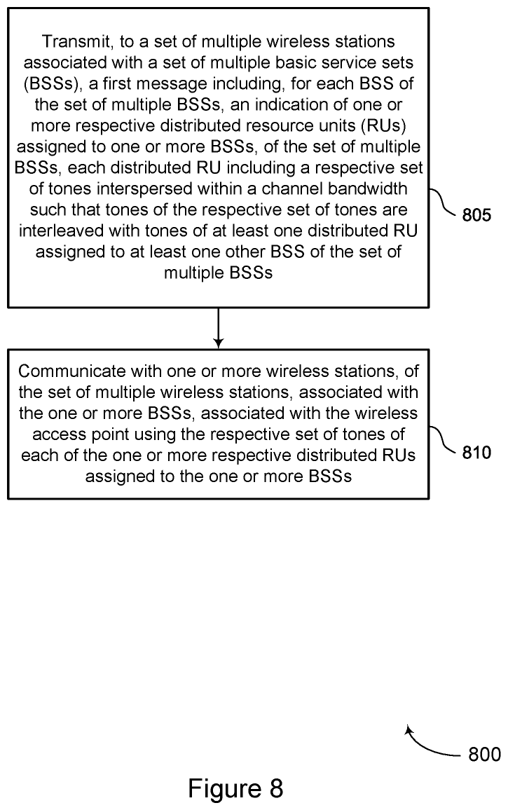

FIG. 8 shows a flowchart illustrating an example process 800 performable at a wireless AP that supports distributed tone transmission in a multiple BSS network topology. The operations of the process 800 may be implemented by a wireless AP or its components as described herein. For example, the operations of the process 800 may be performed by a wireless AP as described with reference to FIGS. 1 through 7 and 14. In some examples, a wireless AP may execute a set of instructions to control the functional elements of the wireless AP to perform the described functions. Additionally, or alternatively, the wireless AP may perform aspects of the described functions using special-purpose hardware.

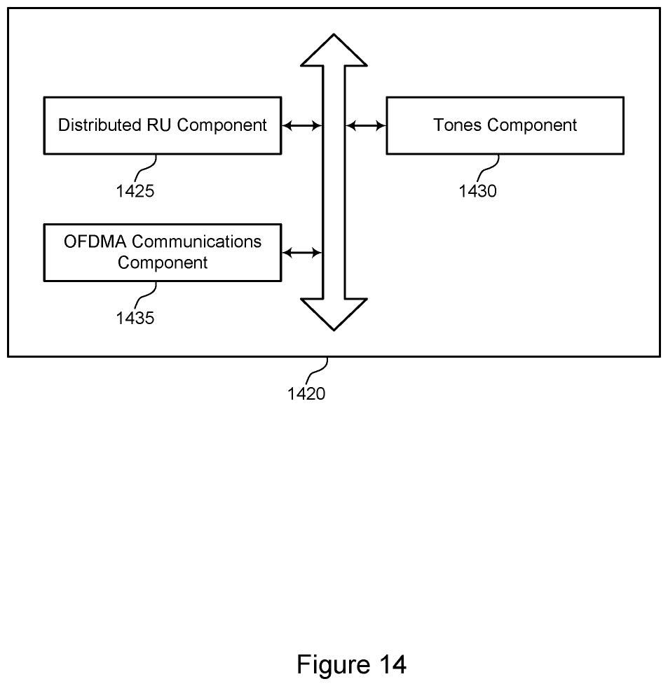

At 805, the method may include transmitting, to a set of multiple wireless stations associated with a set of multiple BSS, a first message including, for each BSS of the set of multiple BSSs, an indication of one or more respective distributed RUs assigned to one or more BSSs, of the set of multiple BSSs, each distributed RU including a respective set of tones interspersed within a channel bandwidth such that tones of the respective set of tones are interleaved with tones of at least one distributed RU assigned to at least one other BSS of the set of multiple BSSs. The operations of 805 may be performed in accordance with examples as disclosed herein. In some examples, aspects of the operations of 805 may be performed by a distributed RU component 1435 as described with reference to FIG. 14.

At 810, the method may include communicating with one or more wireless stations, of the set of multiple wireless stations, associated with the one or more BSSs, associated with the wireless AP using the respective set of tones of each of the one or more respective distributed RUs assigned to the one or more BSSs. The operations of 810 may be performed in accordance with examples as disclosed herein. In some examples, aspects of the operations of 810 may be performed by a tones component 1430 as described with reference to FIG. 14.

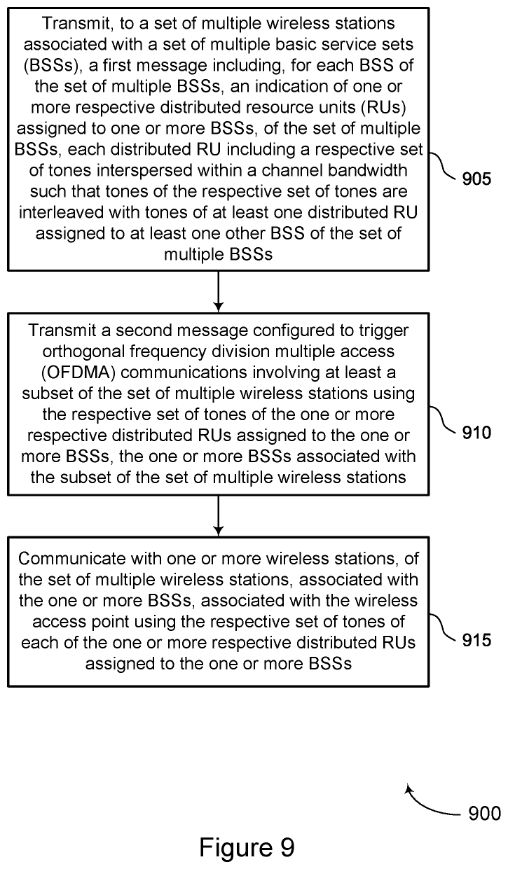

FIG. 9 shows a flowchart illustrating an example process 900 performable at a wireless AP that supports distributed tone transmission in a multiple BSS network topology. The operations of the process 900 may be implemented by a wireless AP or its components as described herein. For example, the operations of the process 900 may be performed by a wireless AP as described with reference to FIGS. 1 through 7 and 14. In some examples, a wireless AP may execute a set of instructions to control the functional elements of the wireless AP to perform the described functions. Additionally, or alternatively, the wireless AP may perform aspects of the described functions using special-purpose hardware.

At 905, the process may include transmitting, to a set of multiple wireless stations associated with a set of multiple BSS, a first message including, for each BSS of the set of multiple BSSs, an indication of one or more respective distributed RUs assigned to one or more BSSs, of the set of multiple BSSs, each distributed RU including a respective set of tones interspersed within a channel bandwidth such that tones of the respective set of tones are interleaved with tones of at least one distributed RU assigned to at least one other BSS of the set of multiple BSSs. The operations of 905 may be performed in accordance with examples as disclosed herein. In some examples, aspects of the operations of 905 may be performed by a distributed RU component 1425 as described with reference to FIG. 14.

At 910, the process may include transmitting a second message to trigger OFDMA communications involving at least a subset of the set of multiple wireless stations using the respective set of tones of the one or more respective distributed RUs assigned to the one or more BSSs, the one or more BSSs associated with the subset of the set of multiple wireless stations. The operations of 910 may be performed in accordance with examples as disclosed herein. In some examples, aspects of the operations of 910 may be performed by an OFDMA communications component 1435 as described with reference to FIG. 14.

At 915, the process may include communicating with one or more wireless stations, of the set of multiple wireless stations, associated with the one or more BSSs, associated with the wireless AP using the respective set of tones of each of the one or more respective distributed RUs assigned to the one or more BSSs. The operations of 915 may be performed in accordance with examples as disclosed herein. In some examples, aspects of the operations of 915 may be performed by a tones component 1430 as described with reference to FIG. 14.

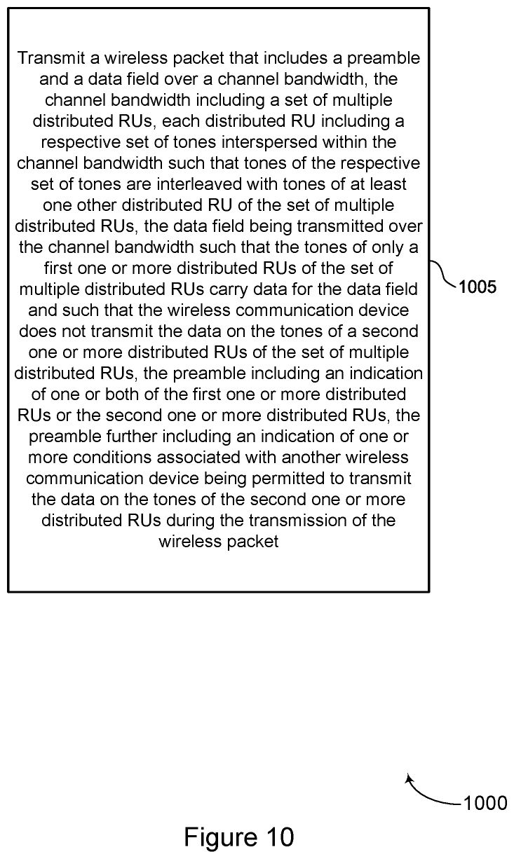

FIG. 10 shows a flowchart illustrating an example process 1000 performable at a wireless communication device that supports distributed tone transmission in a multiple BSS network topology. The operations of the process 1000 may be implemented by a wireless communication device or its components as described herein. For example, the operations of the process 1000 may be performed by a wireless communication device as described with reference to FIGS. 1 through 7 and 15. In some examples, a wireless communication device may execute a set of instructions to control the functional elements of the wireless communication device to perform the described functions. Additionally, or alternatively, the wireless communication device may perform aspects of the described functions using special-purpose hardware.

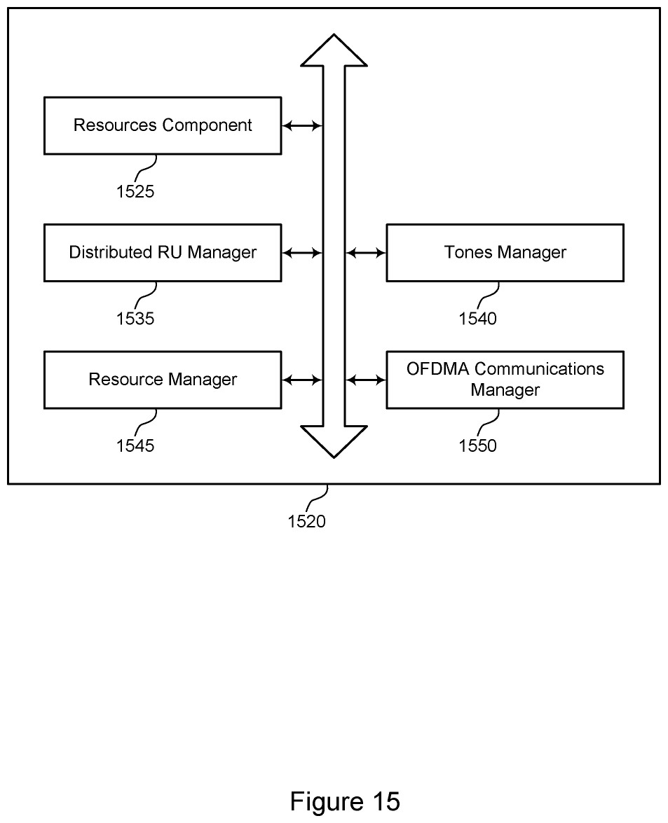

At 1005, the process may include transmitting a wireless packet that includes a preamble and a data field over a channel bandwidth, the channel bandwidth including a set of multiple distributed RUs, each distributed RU including a respective set of tones interspersed within the channel bandwidth such that tones of the respective set of tones are interleaved with tones of at least one other distributed RU of the set of multiple distributed RUs, the data field being transmitted over the channel bandwidth such that the tones of only a first one or more distributed RUs of the set of multiple distributed RUs carry data for the data field and such that the wireless communication device does not transmit the data on the tones of a second one or more distributed RUs of the set of multiple distributed RUs, the preamble including an indication of one or both of the first one or more distributed RUs or the second one or more distributed RUs, the preamble further including an indication of one or more conditions associated with another wireless communication device being permitted to transmit the data on the tones of the second one or more distributed RUs during the transmission of the wireless packet. The operations of 1005 may be performed in accordance with examples as disclosed herein. In some examples, aspects of the operations of 1005 may be performed by a resources component 1525 as described with reference to FIG. 15.

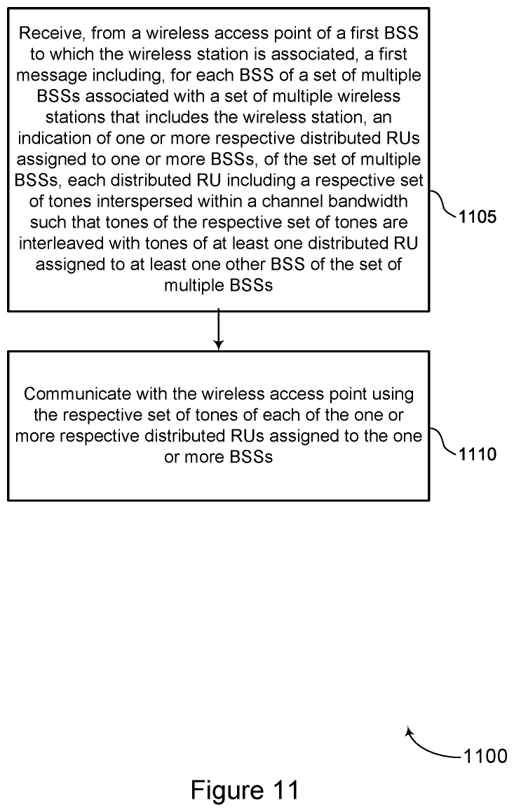

FIG. 11 shows a flowchart illustrating an example process 1100 performable at a wireless AP that supports distributed tone transmission in a multiple BSS network topology. The operations of the process 1100 may be implemented by a STA or its components as described herein. For example, the operations of the process 1100 may be performed by a STA as described with reference to FIGS. 1 through 7 and 15. In some examples, a STA may execute a set of instructions to control the functional elements of the STA to perform the described functions. Additionally, or alternatively, the STA may perform aspects of the described functions using special-purpose hardware.

At 1105, the process may include receiving, from a wireless access point of a first BSS to which the wireless station is associated, a first message including, for each BSS of a set of multiple BSSs associated with a set of multiple wireless stations that includes the wireless station, an indication of one or more respective distributed RUs assigned to one or more BSSs, of the set of multiple BSSs, each distributed RU including a respective set of tones interspersed within a channel bandwidth such that tones of the respective set of tones are interleaved with tones of at least one distributed RU assigned to at least one other BSS of the set of multiple BSSs. The operations of 1105 may be performed in accordance with examples as disclosed herein. In some examples, aspects of the operations of 1105 may be performed by a distributed RU manager 1535 as described with reference to FIG. 15.

At 1110, the process may include communicating with the wireless access point using the respective set of tones of each of the one or more respective distributed RUs assigned to the one or more BSSs. The operations of 1110 may be performed in accordance with examples as disclosed herein. In some examples, aspects of the operations of 1110 may be performed by a tones manager 1540 as described with reference to FIG. 15.

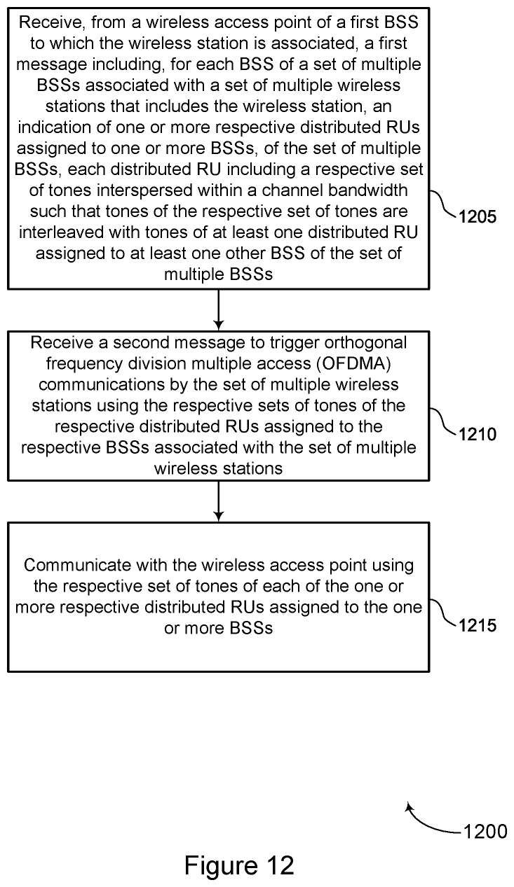

FIG. 12 shows a flowchart illustrating an example process 1200 performable at a wireless AP that supports distributed tone transmission in a multiple BSS network topology. The operations of the process 1200 may be implemented by a STA or its components as described herein. For example, the operations of the process 1200 may be performed by a STA as described with reference to FIGS. 1 through 7 and 15. In some examples, a STA may execute a set of instructions to control the functional elements of the STA to perform the described functions. Additionally, or alternatively, the STA may perform aspects of the described functions using special-purpose hardware.

At 1205, the process may include receiving, from a wireless access point of a first BSS to which the wireless station is associated, a first message including, for each BSS of a set of multiple BSSs associated with a set of multiple wireless stations that includes the wireless station, an indication of one or more respective distributed RUs assigned to one or more BSSs, of the set of multiple BSSs, each distributed RU including a respective set of tones interspersed within a channel bandwidth such that tones of the respective set of tones are interleaved with tones of at least one distributed RU assigned to at least one other BSS of the set of multiple BSSs. The operations of 1205 may be performed in accordance with examples as disclosed herein. In some examples, aspects of the operations of 1205 may be performed by a distributed RU manager 1535 as described with reference to FIG. 15.

At 1210, the process may include receiving a second message to trigger OFDMA communications by the set of multiple wireless stations using the respective sets of tones of the respective distributed RUs assigned to the respective BSSs associated with the set of multiple wireless stations. The operations of 1210 may be performed in accordance with examples as disclosed herein. In some examples, aspects of the operations of 1210 may be performed by an OFDMA communications manager 1550 as described with reference to FIG. 15.

At 1215, the process may include communicating with the wireless access point using the respective set of tones of each of the one or more respective distributed RUs assigned to the one or more BSSs. The operations of 1215 may be performed in accordance with examples as disclosed herein. In some examples, aspects of the operations of 1215 may be performed by a tones manager 1540 as described with reference to FIG. 15.

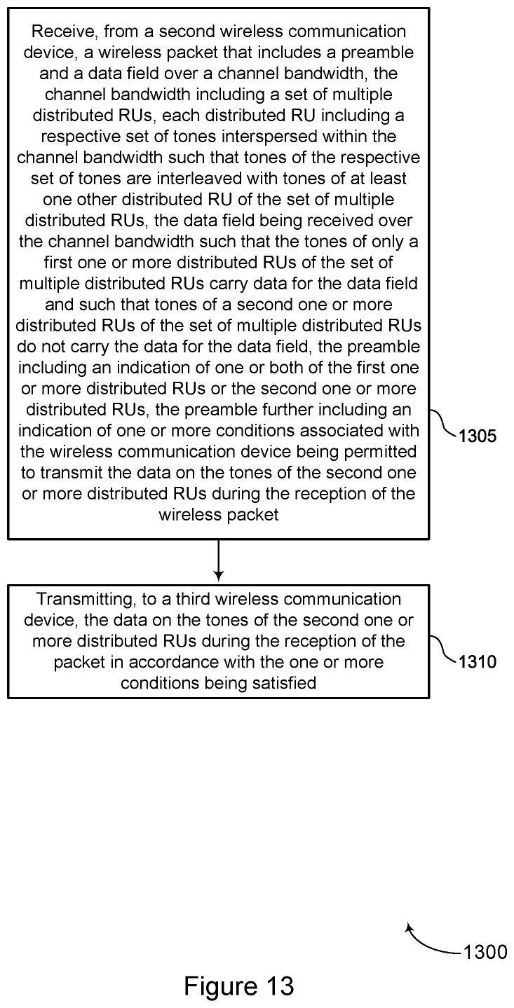

FIG. 13 shows a flowchart illustrating an example process 1300 performable at a wireless communication device that supports distributed tone transmission in a multiple BSS network topology. The operations of the process 1300 may be implemented by a wireless communication device or its components as described herein. For example, the operations of the process 1300 may be performed by a wireless communication device as described with reference to FIGS. 1 through 7 and 15. In some examples, a wireless communication device may execute a set of instructions to control the functional elements of the wireless communication device to perform the described functions. Additionally, or alternatively, the wireless communication device may perform aspects of the described functions using special-purpose hardware.

At 1305, the process may include receiving, from a second wireless communication device, a wireless packet that includes a preamble and a data field over a channel bandwidth, the channel bandwidth including a set of multiple distributed RUs, each distributed RU including a respective set of tones interspersed within the channel bandwidth such that tones of the respective set of tones are interleaved with tones of at least one other distributed RU of the set of multiple distributed RUs, the data field being received over the channel bandwidth such that the tones of only a first one or more distributed RUs of the set of multiple distributed RUs carry data for the data field and such that tones of a second one or more distributed RUs of the set of multiple distributed RUs do not carry the data for the data field, the preamble including an indication of one or both of the first one or more distributed RUs or the second one or more distributed RUs, the preamble further including an indication of one or more conditions associated with the wireless communication device being permitted to transmit the data on the tones of the second one or more distributed RUs during the reception of the wireless packet. The operations of 1305 may be performed in accordance with examples as disclosed herein. In some examples, aspects of the operations of 1305 may be performed by a resource manager 1545 as described with reference to FIG. 15.

At 1310, the process may include transmitting, to a third wireless communication device, the data on the tones of the second one or more distributed RUs during the reception of the packet in accordance with the one or more conditions being satisfied. The operations of 1310 may be performed in accordance with examples as disclosed herein. In some examples, aspects of the operations of 1310 may be performed by a tones manager 1540 as described with reference to FIG. 15.

FIG. 14 shows a block diagram of an example wireless communication device 1420 that supports distributed tone transmission in a multiple BSS network topology according to some aspects of the present disclosure. In some examples, the wireless communication device 1420 is configured or operable to perform the process 800 and 900 described with reference to FIGS. 8 and 9. In various examples, the wireless communication device 1420 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1420 can be a device for use in a wireless AP, such as AP 102 described with reference to FIG. 1. In some other examples, the wireless communication device 1420 can be a wireless AP that includes such a chip, SoC, chipset, package or device as well as multiple antennas. The wireless communication device 1420 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1420 also includes or can be coupled with an application processor which may be further coupled with another memory. In some examples, the wireless communication device 1420 further includes at least one external network interface that enables communication with a core network or backhaul network to gain access to external networks including the Internet.

The wireless communication device 1420, or various components thereof, may be an example of means for performing various aspects of distributed tone transmission in a multiple BSS network topology as described herein. For example, the wireless communication device 1420 may include a distributed RU component 1425, a tones component 1430, an OFDMA communications component 1435, or any combination thereof. Each of these components may communicate, directly or indirectly, with one another (for example, via one or more buses).

The communications device 1420 may support wireless communication at a wireless AP in accordance with examples as disclosed herein. The distributed RU component 1425 may be configured as or otherwise support a means for transmitting, to a set of multiple wireless stations associated with a set of multiple BSS, a first message including, for each BSS of the set of multiple BSSs, an indication of one or more respective distributed RUs assigned to one or more BSSs, of the set of multiple BSSs, each distributed RU including a respective set of tones interspersed within a channel bandwidth such that tones of the respective set of tones are interleaved with tones of at least one distributed RU assigned to at least one other BSS of the set of multiple BSSs. The tones component 1430 may be configured as or otherwise support a means for communicating with one or more wireless stations, of the set of multiple wireless stations, associated with the one or more BSSs, associated with the wireless AP using the respective set of tones of each of the one or more respective distributed RUs assigned to the one or more BSSs.

In some examples, the OFDMA communications component 1435 may be configured as or otherwise support a means for transmitting a second message configured to trigger OFDMA communications involving at least a subset of the set of multiple wireless stations using the respective set of tones of the one or more respective distributed RUs assigned to the one or more BSSs associated with the subset of the set of multiple wireless stations.

In some examples, the first message and the second message are both transmitted in a same packet.

In some examples, the first message and the second message are transmitted in different respective packets.

In some examples, the second message is configured to synchronize communications to or from the set of multiple wireless stations in a time domain.

In some examples, the first message is transmitted in accordance with a determination that at least one wireless station of the set of multiple wireless stations is operating in a channel that satisfies a PSD threshold value.

FIG. 15 shows a block diagram of an example wireless communication device 1520 that supports distributed tone transmission in a multiple BSS network topology according to some aspects of the present disclosure. In some examples, the wireless communication device 1520 is configured or operable to perform the process 1000 through 1400 described with reference to FIGS. 10 through 14. In various examples, the wireless communication device 1520 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1520 can be a device for use in a wireless AP and/or a wireless STA, such as AP 102 or a STA 104 described with reference to FIG. 1. In some other examples, the wireless communication device 1520 can be a wireless AP and/or a wireless STA that includes such a chip, SoC, chipset, package or device as well as multiple antennas. The wireless communication device 1520 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1520 also includes or can be coupled with an application processor which may be further coupled with another memory. In some examples, the wireless communication device 1520 further includes at least one external network interface that enables communication with a core network or backhaul network to gain access to external networks including the Internet.

The communications device 1520, or various components thereof, may be an example of means for performing various aspects of distributed tone transmission in a multiple BSS network topology as described herein. For example, the communications device 1520 may include a resources component 1525, a distributed RU manager 1535, a tones manager 1540, a resource manager 1545, an OFDMA communications manager 1550, or any combination thereof. Each of these components may communicate, directly or indirectly, with one another (for example, via one or more buses).

The communications device 1520 may support wireless communication associated with a first BSS in accordance with examples as disclosed herein. The resources component 1525 may be configured as or otherwise support a means for transmitting a wireless packet that includes a preamble and a data field over a channel bandwidth, the channel bandwidth including a set of multiple distributed RUs, each distributed RU including a respective set of tones interspersed within the channel bandwidth such that tones of the respective set of tones are interleaved with tones of at least one other distributed RU of the set of multiple distributed RUs, the data field being transmitted over the channel bandwidth such that the tones of only a first one or more distributed RUs of the set of multiple distributed RUs carry data for the data field and such that the wireless communication device 1520 does not transmit the data on the tones of a second one or more distributed RUs of the set of multiple distributed RUs, the preamble including an indication of one or both of the first one or more distributed RUs or the second one or more distributed RUs, the preamble further including an indication of one or more conditions associated with another wireless communication device being permitted to transmit the data on the tones of the second one or more distributed RUs during the transmission of the wireless packet

In some examples, the preamble is configured to synchronize communications by the wireless communication device 1520 and the other wireless communication device in a time domain.

In some examples, the preamble is configured to align a start of the data on the tones of the second one or more distributed RUs with an UHR-STF of the preamble, the data corresponding to the other wireless communication device.

In some examples, the preamble is configured to align a start of the data on the tones of the second one or more distributed RUs with an initial data symbol of the preamble.

Additionally, or alternatively, the communications device 1520 may support wireless communications at a wireless STA in accordance with examples as disclosed herein. The distributed RU manager 1535 may be configured as or otherwise support a means for receiving, from a wireless AP of a first BSS to which the wireless STA is associated, a first message including, for each BSS of a set of multiple BSSs associated with a set of multiple wireless STAs that includes the wireless STA, an indication of one or more respective distributed RUs assigned to one or more BSSs, of the set of multiple BSSs, each distributed RU including a respective set of tones interspersed within a channel bandwidth such that tones of the respective set of tones are interleaved with tones of at least one distributed RU assigned to at least one other BSS of the set of multiple BSSs. The tones manager 1540 may be configured as or otherwise support a means for communicating with the wireless AP using the respective set of tones of each of the one or more respective distributed RUs assigned to the one or more BSSs.

In some examples, the OFDMA communications manager 1550 may be configured as or otherwise support a means for receiving, from the wireless AP, a second message configured to trigger OFDMA communications involving at least a subset of the set of multiple wireless STAs using the respective set of tones of the one or more respective distributed RUs assigned to the one or more BSSs, the one or more BSSs associated with the subset of the set of multiple wireless STAs, wherein the communication with the wireless AP includes transmitting an uplink communication to the wireless AP associated with receiving the second message.

In some examples, the first message and the second message are both transmitted in a same packet.

In some examples, the first message and the second message are transmitted in different respective packets.

In some examples, the second message is configured to synchronize communications to or from the set of multiple wireless STAs, including the wireless STA, in a time domain.

In some examples, the wireless STA is operating in a channel that satisfies a PSD threshold value.

Additionally, or alternatively, the communications device 1520 may support wireless communication associated with a first BSS in accordance with examples as disclosed herein. The resource manager 1545 may be configured as or otherwise support a means for receiving, from a second wireless communication device 1520, a wireless packet that includes a preamble and a data field over a channel bandwidth, the channel bandwidth including a set of multiple distributed RUs, each distributed RU including a respective set of tones interspersed within the channel bandwidth such that tones of the respective set of tones are interleaved with tones of at least one other distributed RU of the set of multiple distributed RUs, the data field being received over the channel bandwidth such that the tones of only a first one or more distributed RUs of the set of multiple distributed RUs carry data for the data field and such that tones of a second one or more distributed RUs of the set of multiple distributed RUs do not carry the data for the data field, the preamble including an indication of one or both of the first one or more distributed RUs or the second one or more distributed RUs, the preamble further including an indication of one or more conditions associated with the wireless communication device 1520 being permitted to transmit the data on the tones of the second one or more distributed RUs during the reception of the wireless packet. In some examples, the tones manager 1540 may be configured as or otherwise support a means for transmitting, to a third wireless communication device, the data on the tones of the second one or more distributed RUs during the reception of the packet in accordance with the one or more conditions being satisfied.

In some examples, the preamble is configured to synchronize communications by the wireless communication device 1520 and the second wireless communication device in a time domain.

In some examples, the preamble is configured to align a start of the data on the tones of the second one or more distributed RUs with an UHR-STF of the preamble.

In some examples, the preamble is configured to align a start of the data on the tones of the second one or more distributed RUs with an initial data symbol of the preamble.

In some examples, wherein the tones of the second one or more distributed RUs correspond to a first distributed RU channel in accordance with the transmission corresponding to a second distributed RU channel.

In some examples, the transmission is in accordance with an UHR-STF, an UHR-LTF, a signal field indicating one or more parameters for data demodulation, or any combination thereof.

In some examples, the OFDMA communications manager 1550 may be configured as or otherwise support a means for aligning a time domain symbol boundary of the data corresponding to the first one or more distributed RUs within a duration of the data field.

In some examples, the transmission satisfies a transmit power threshold value associated with the wireless communication device 1520.

In some examples, the transmission satisfies an interference threshold value associated with the wireless communication device 1520.

In some examples, the preamble of the wireless packet triggers the transmission of the data on the tones of the second one or more distributed RUs.

It should be noted that the methods described herein describe possible implementations, and that the operations and the steps may be rearranged or otherwise modified and that other implementations are possible. Furthermore, aspects from two or more of the methods may be combined.

The following provides an overview of aspects of the present disclosure:

Aspect 1: A method for wireless communication at a wireless access point, comprising: transmitting, to a plurality of wireless stations associated with a plurality of basic service sets (BSSs), a first message comprising, for each BSS of the plurality of BSSs, an indication of one or more respective distributed resource units (RUs) assigned to one or more BSSs, of the plurality of BSSs, each distributed RU comprising a respective set of tones interspersed within a channel bandwidth such that tones of the respective set of tones are interleaved with tones of at least one distributed RU assigned to at least one other BSS of the plurality of BSSs; and communicating with one or more wireless stations, of the plurality of wireless stations, associated with the one or more BSSs, associated with the wireless access point using the respective set of tones of each of the one or more respective distributed RUs assigned to the one or more BSSs.

Aspect 2: The method of aspect 1, further comprising: transmitting a second message to trigger orthogonal frequency division multiple access (OFDMA) communications involving at least a subset of wireless stations using the respective set of tones of the one or more respective distributed RUs assigned to the one or more BSSs, the one or more BSSs associated with the subset of the plurality of wireless stations.

Aspect 3: The method of aspect 2, wherein the first message and the second message are both transmitted in a same packet.

Aspect 4: The method of aspect 2, wherein the first message and the second message are transmitted in different respective packets.

Aspect 5: The method of any of aspects 2 through 4, wherein the second message is configured to synchronize communications to or from the plurality of wireless stations associated in a time domain.

Aspect 6: The method of any of aspects 1 through 5, wherein the first message is transmitted in accordance with a determination that at least one wireless station of the plurality of wireless stations is operating in a channel that satisfies a power spectral density threshold value.

Aspect 7: A method for wireless communication at a wireless communication device, comprising: transmitting a wireless packet that includes a preamble and a data field over a channel bandwidth, the channel bandwidth comprising a plurality of distributed resource units (RUs), each distributed RU comprising a respective set of tones interspersed within the channel bandwidth such that tones of the respective set of tones are interleaved with tones of at least one other distributed RU of the plurality of distributed RUs, the data field being transmitted over the channel bandwidth such that the tones of only a first one or more distributed RUs of the plurality of distributed RUs carry data for the data field and such that the wireless communication device does not transmit the data on the tones of a second one or more distributed RUs of the plurality of distributed RUs, the preamble including an indication of one or both of the first one or more distributed RUs or the second one or more distributed RUs, the preamble further including an indication of one or more conditions associated with another wireless communication device being permitted to transmit the data on the tones of the second one or more distributed RUs during the transmission of the wireless packet.

Aspect 8: The method of aspect 7, wherein the preamble is configured to synchronize communications by the wireless communication device and the other wireless communication device in a time domain.

Aspect 9: The method of aspect 8, wherein the preamble is configured to align a start of the data on the tones of the second one or more distributed RUs with an ultra-high reliability-short training field of the preamble, the data corresponding to the other wireless communication device.

Aspect 10: The method of aspect 8, wherein the preamble is configured to align a start of the data on the tones of the second one or more distributed RUs with an initial data symbol of the preamble.

Aspect 11: A method for wireless communications at a wireless station, comprising: receiving, from a wireless access point of a first basic service set (BSS) to which the wireless station is associated, a first message comprising, for each BSS of a plurality of BSSs associated with a plurality of wireless stations that includes the wireless station, an indication of one or more respective distributed resource units (RUS) assigned to one or more BSSs, of the plurality of BSSs, each distributed RU comprising a respective set of tones interspersed within a channel bandwidth such that tones of the respective set of tones are interleaved with tones of at least one distributed RU assigned to at least one other BSS of the plurality of BSSs; and communicating with the wireless access point using the respective set of tones of each of the one or more respective distributed RUs assigned to the one or more BSSs.

Aspect 12: The method of aspect 11, further comprising: receiving, from the wireless access point, a second message configured to trigger orthogonal frequency division multiple access (OFDMA) communications involving at least a subset of the plurality of wireless stations using the respective set of tones of the one or more respective distributed RUs assigned to the one or more BSSs, the one or more BSSs associated with the subset of wireless stations, wherein the communication with the wireless access point comprises transmitting an uplink communication to the wireless access point associated with receiving the second message.

Aspect 13: The method of aspect 12, wherein the first message and the second message are both transmitted in a same packet.

Aspect 14: The method of aspect 12, wherein the first message and the second message are transmitted in different respective packets.

Aspect 15: The method of any of aspects 11 through 14, wherein the second message is configured to synchronize communications to or from the plurality of wireless stations, including the wireless station, in a time domain.

Aspect 16: The method of any of aspects 11 through 15, wherein the wireless station is operating in a channel that satisfies a power spectral density threshold value.

Aspect 17: A method for wireless communication at a wireless communication device associated with a first basic service set (BSS), comprising: receiving, from a second wireless communication device, a wireless packet that includes a preamble and a data field over a channel bandwidth, the channel bandwidth comprising a plurality of distributed resource units (RUs), each distributed RU comprising a respective set of tones interspersed within the channel bandwidth such that tones of the respective set of tones are interleaved with tones of at least one other distributed RU of the plurality of distributed RUs, the data field being received over the channel bandwidth such that the tones of only a first one or more distributed RUs of the plurality of distributed RUs carry data for the data field and such that tones of a second one or more distributed RUs of the plurality of distributed RUs do not carry the data for the data field, the preamble including an indication of one or both of the first one or more distributed RUs or the second one or more distributed RUs, the preamble further including an indication of one or more conditions associated with the wireless communication device being permitted to transmit the data on the tones of the second one or more distributed RUs during the reception of the wireless packet; and transmitting, to a third wireless communication device, the data on the tones of the second one or more distributed RUs during the reception of the packet in accordance with the one or more conditions being satisfied.

Aspect 18: The method of aspect 17, wherein the preamble is configured to synchronize communications by the wireless communication device and the second wireless communication device in a time domain.

Aspect 19: The method of aspect 18, wherein the preamble is configured to align a start of the data on the tones of the second one or more distributed RUs with an ultra-high reliability-short training field of the preamble.

Aspect 20: The method of aspect 18, wherein the preamble is configured to align a start of the data on the tones of the second one or more distributed RUs with an initial data symbol of the preamble.

Aspect 21: The method of any of aspects 17 through 20, wherein the tones of the second one or more distributed RUs correspond to a first distributed RU channel in accordance with the transmission corresponding to a second distributed RU channel.

Aspect 22: The method of any of aspects 17 through 21, wherein the transmission is in accordance with an ultra-high reliability short training field, an ultra-high reliability long training field, an ultra-high reliability signal field indicating one or more parameters for data demodulation, or any combination thereof.

Aspect 23: The method of any of aspects 17 through 22, further comprising aligning a time domain symbol boundary of the data corresponding to the first one or more distributed RUs within a duration of the data field.

Aspect 24: The method of any of aspects 17 through 23, wherein the transmission satisfies a transmit power threshold value associated with the wireless communication device.

Aspect 25: The method of any of aspects 17 through 24, wherein the transmission satisfies an interference threshold value associated with the wireless communication device.

Aspect 26: The method of any of aspects 17 through 25, wherein the preamble of the wireless packet triggers the transmission of the data on the tones of the second one or more distributed RUs.

Aspect 27: An apparatus for wireless communication at a wireless access point, comprising a processor; memory coupled with the processor; and instructions stored in the memory and executable by the processor to cause the apparatus to perform a method of any of aspects 1 through 6.

Aspect 26: An apparatus for wireless communication at a wireless access point, comprising at least one means for performing a method of any of aspects 1 through 6.

Aspect 27: A non-transitory computer-readable medium storing code for wireless communication at a wireless access point, the code comprising instructions executable by a processor to perform a method of any of aspects 1 through 6.

Aspect 28: An apparatus for wireless communication at a wireless communication device associated with a first basic service set (BSS), comprising a processor; memory coupled with the processor; and instructions stored in the memory and executable by the processor to cause the apparatus to perform a method of any of aspects 7 through 10.

Aspect 29: An apparatus for wireless communication at a wireless communication device associated with a first basic service set (BSS), comprising at least one means for performing a method of any of aspects 7 through 10.

Aspect 30: A non-transitory computer-readable medium storing code for wireless communication at a wireless communication device associated with a first basic service set (BSS), the code comprising instructions executable by a processor to perform a method of any of aspects 7 through 10.

Aspect 31: An apparatus for wireless communications at a wireless communication device, comprising a processor; memory coupled with the processor; and instructions stored in the memory and executable by the processor to cause the apparatus to perform a method of any of aspects 11 through 16.

Aspect 32: An apparatus for wireless communications at a wireless station, comprising at least one means for performing a method of any of aspects 11 through 16.

Aspect 33: A non-transitory computer-readable medium storing code for wireless communications at a wireless station, the code comprising instructions executable by a processor to perform a method of any of aspects 11 through 16.

Aspect 34: An apparatus for wireless communication at a wireless communication device associated with a first basic service set (BSS), comprising a processor; memory coupled with the processor; and instructions stored in the memory and executable by the processor to cause the apparatus to perform a method of any of aspects 17 through 26.

Aspect 35: An apparatus for wireless communication at a wireless communication device associated with a first basic service set (BSS), comprising at least one means for performing a method of any of aspects 17 through 26.

Aspect 36: A non-transitory computer-readable medium storing code for wireless communication at a wireless communication device associated with a first basic service set (BSS), the code comprising instructions executable by a processor to perform a method of any of aspects 17 through 26.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method for wireless communication at a wireless access point, comprising:
transmitting, to a plurality of wireless stations associated with a plurality of basic service sets (BSSs), a first message comprising, for each BSS of the plurality of BSSs, an indication of one or more respective distributed resource units (RUs) assigned to one or more BSSs, of the plurality of BSSs, each distributed RU comprising a respective set of tones interspersed within a channel bandwidth such that tones of the respective set of tones are interleaved with tones of at least one distributed RU assigned to at least one other BSS of the plurality of BSSs; and
communicating with one or more wireless stations, of the plurality of wireless stations, associated with the one or more BSSs, associated with the wireless access point using the respective set of tones of each of the one or more respective distributed RUs assigned to the one or more BSSs.

2. The method of claim 1, further comprising transmitting a second message configured to trigger orthogonal frequency division multiple access (OFDMA) communications involving at least a subset of the plurality of wireless stations using the respective set of tones of the one or more respective distributed RUs assigned to the one or more BSSs, the one or more BSSs associated with the subset of the plurality of wireless stations.

3. The method of claim 2, wherein the first message and the second message are both transmitted in a same packet.

4. The method of claim 2, wherein the first message and the second message are transmitted in different respective packets.

5. The method of claim 2, wherein the second message is configured to synchronize communications to or from the plurality of wireless stations in a time domain.

6. The method of claim 1, wherein the first message is transmitted in accordance with a determination that at least one wireless station of the plurality of wireless stations is operating in a channel that satisfies a power spectral density threshold value.

7. A method for wireless communication at a wireless communication device, comprising:
transmitting a wireless packet that includes a preamble and a data field over a channel bandwidth, the channel bandwidth comprising a plurality of distributed resource units (RUs), each distributed RU comprising a respective set of tones interspersed within the channel bandwidth such that tones of the respective set of tones are interleaved with tones of at least one other distributed RU of the plurality of distributed RUs, the data field being transmitted over the channel bandwidth such that the tones of only a first one or more distributed RUs of the plurality of distributed RUs carry data for the data field and such that the wireless communication device does not transmit the data on the tones of a second one or more distributed RUs of the plurality of distributed RUs, the preamble including an indication of one or both of the first one or more distributed RUs or the second one or more distributed RUs, the preamble further including an indication of one or more conditions associated with another wireless communication device being permitted to transmit the data on the tones of the second one or more distributed RUs during the transmission of the wireless packet.

8. The method of claim 7, wherein the preamble is configured to synchronize communications by the wireless communication device and the other wireless communication device in a time domain.

9. The method of claim 8, wherein the preamble is configured to align a start of the data on the tones of the second one or more distributed RUs with an ultra-high reliability-short training field of the preamble, the data corresponding to the other wireless communication device.

10. The method of claim 8, wherein the preamble is configured to align a start of the data on the tones of the second one or more distributed RUs with an initial data symbol of the preamble.

11. A method for wireless communications at a wireless station, comprising:
receiving, from a wireless access point of a first basic service set (BSS) to which the wireless station is associated, a first message comprising, for each BSS of a plurality of BSSs associated with a plurality of wireless stations that includes the wireless station, an indication of one or more respective distributed resource units (RUs) assigned to one or more BSSs, of the plurality of BSSs, each distributed RU comprising a respective set of tones interspersed within a channel bandwidth such that tones of the respective set of tones are interleaved with tones of at least one distributed RU assigned to at least one other BSS of the plurality of BSSs; and
communicating with the wireless access point using the respective set of tones of each of the one or more respective distributed RUs assigned to the one or more BSSs.

12. The method of claim 11, further comprising:
receiving, from the wireless access point, a second message configured to trigger orthogonal frequency division multiple access (OFDMA) communications involving at least a subset of the plurality of wireless stations using the respective set of tones of the one or more respective distributed RUs assigned to the one or more BSSs, the one or more BSSs associated with the subset of the plurality of wireless stations, wherein the communication with the wireless access point comprises transmitting an uplink communication to the wireless access point associated with receiving the second message.

13. The method of claim 12, wherein the first message and the second message are both received in a same packet.

14. The method of claim 12, wherein the first message and the second message are received in different respective packets.

15. The method of claim 12, wherein the second message is configured to synchronize communications to or from the plurality of wireless stations, including the wireless station, in a time domain.

16. The method of claim 11, wherein the wireless station is operating in a channel that satisfies a power spectral density threshold value.

17. A method for wireless communication at a wireless communication device associated with a first basic service set (BSS), comprising:
receiving, from a second wireless communication device, a wireless packet that includes a preamble and a data field over a channel bandwidth, the channel bandwidth comprising a plurality of distributed resource units (RUs), each distributed RU comprising a respective set of tones interspersed within the channel bandwidth such that tones of the respective set of tones are interleaved with tones of at least one other distributed RU of the plurality of distributed RUs, the data field being received over the channel bandwidth such that the tones of only a first one or more distributed RUs of the plurality of distributed RUs carry data for the data field and such that tones of a second one or more distributed RUs of the plurality of distributed RUs do not carry the data for the data field, the preamble including an indication of one or both of the first one or more distributed RUs or the second one or more distributed RUs, the preamble further including an indication of one or more conditions associated with the wireless communication device being permitted to transmit the data on the tones of the second one or more distributed RUs during the reception of the wireless packet; and
transmitting, to a third wireless communication device, the data on the tones of the second one or more distributed RUs during the reception of the packet in accordance with the one or more conditions being satisfied.

18. The method of claim 17, wherein the preamble is configured to synchronize communications by the wireless communication device and the second wireless communication device in a time domain.

19. The method of claim 18, wherein the preamble is configured to align a start of the data on the tones of the second one or more distributed RUs with an ultra-high reliability-short training field of the preamble.

20. The method of claim 18, wherein the preamble is configured to align a start of the data on the tones of the second one or more distributed RUs with an initial data symbol of the preamble.

21. The method of claim 17, wherein the tones of the second one or more distributed RUs correspond to a first distributed RU channel in accordance with the transmission corresponding to a second distributed RU channel.

22. The method of claim 17, wherein the transmission is in accordance with an ultra-high reliability short training field, an ultra-high reliability long training field, an ultra-high reliability signal field indicating one or more parameters for data demodulation, or any combination thereof.

23. The method of claim 17, further comprising aligning a time domain symbol boundary of the data corresponding to the first one or more distributed RUs within a duration of the data field.

24. The method of claim 17, wherein the transmission satisfies a transmit power threshold value associated with the wireless communication device.

25. The method of claim 17, wherein the transmission satisfies an interference threshold value associated with the wireless communication device.

26. The method of claim 17, wherein the preamble of the wireless packet triggers the transmission of the data on the tones of the second one or more distributed RUs.
